(19) United States
(12) Patent Application Publication
(10) Pub. No.: US 2025/0125971 A1
(43) Pub. Date: Apr. 17, 2025

(54) SYSTEM AND METHOD FOR A LEGAL FABRIC ENABLING EXCHANGE OF INFORMATION

(71) Applicant: Ilan Hornstein, Menlo Park, CA (US)

(72) Inventor: Ilan Hornstein, Menlo Park, CA (US)

(21) Appl. No.: 18/488,874

(22) Filed: Oct. 17, 2023

(51) Int. Cl. H04L 9/32; G06Q 50/18

(52) U.S. Cl. CPC H04L 9/3247; G06Q 50/18

(57) ABSTRACT

An electronic system for creating and maintaining a network of companies having legal obligations with each other, includes: an electronic legal document provider configured to electronically provide a legal document; and obtain a signed legal document for a company, wherein the signed legal document is based on an electronic signature applied for the legal document; a subscription engine configured to obtain subscription information for the company, and register the company as a subscriber for the network of companies based on the subscription information; and a processing unit configured to obtain blockchain information associated with a block of a blockchain, wherein the block of the blockchain is created based on the signed legal document after the company is registered as the subscriber for the network of companies.

### FIELD

The present disclosure relates generally to the field of electronic and physical information exchange, and more specifically to a new and useful system and method for a legal fabric enabling the exchange of information, particularly confidential information such as trade secrets and other proprietary information.

### BACKGROUND

Exchanging information among persons, including businesses, is a basic necessity of society and commerce. However, exchanging information, particularly confidential information such as trade secrets and other proprietary information, is made difficult by the laws that frame the foundation on which such exchanges occur. The difficulty stems from the fact that the law does not automatically recognize all information typically desired to be considered confidential information as confidential information and will render trade secrets automatically unenforceable if its owner does not take certain prescribed steps to ensure its protection and confidential treatment. Furthermore, the law both fails to impose certain desired duties on a recipient of information and, at the same time, imposes undesired duties (and rights) on the recipient of information and on the discloser of information. Lastly, the mere existence of the agreement is an indicator of two particular persons wishing to do business, which in itself is information that typically needs to be protected from disclosure. As a result, persons who wish to exchange information are forced to enter into an agreement to define and protect information, modify the rules that apply by default, and establish additional rules on which they will exchange information.

With respect to confidential information in particular, the existing solution to the problem described in paragraph 2 is to enter into agreements typically called Non-disclosure Agreements or NDAs. However, every company has its own forms of NDAs, much confusion exists in what should or should not be in NDAs, the disparity in bargaining power between two entities, say a small company wishing to do business with a very large company, often results in lopsided NDA obligations favoring the party with more bargaining power, and some companies sign NDAs that later turn out to not provide even the minimum protection necessary. The result is wasted time, effort, and money (estimated at hundreds of millions of dollars per year) negotiating NDAs and a lot of interest in solving the problem. However, all solutions known to date have focused either on changing the laws, which changes have not succeeded in eliminating NDA negotiations, or changing elements of the NDA negotiation process to try to reduce the time, effort, or cost of NDAs. For example, inventions exist that automate NDA creation, such as the much fabled “one-click NDA” or clause-library solutions, or that attempt to speed review cycles through novel computer systems, such as web-forms or contract management systems. Other approaches have been social attempts to standardize NDAs and have companies adopt the standardized NDA as their NDA in negotiations. However, for all of these negotiations the fundamental flaw of the system remains that requires the parties to exchange contracts, engage in the battle of the forms to see whose form will be used, and verify and negotiate among themselves. And for each NDA, the parties must adapt their behavior to the unique requirements of that NDA. The free exchange of confidential information is still not possible.

Thus, there is a need in the field of electronic and physical information exchange for a new and useful system and method for a legal fabric enabling the free exchange of information, particularly confidential information such as trade secrets and other proprietary information.

### SUMMARY

An electronic system for creating and maintaining a network of companies having legal obligations with each other, includes: an electronic legal document provider configured to electronically provide a legal document; and obtain a signed legal document for a company, wherein the signed legal document is based on an electronic signature applied for the legal document; a subscription engine configured to obtain subscription information for the company, and register the company as a subscriber for the network of companies based on the subscription information; and a processing unit configured to obtain blockchain information associated with a block of a blockchain, wherein the block of the blockchain is created based on the signed legal document after the company is registered as the subscriber for the network of companies.

Optionally, the processing unit is configured to interface with a blockchain engine configured to create the block of the blockchain, and to link the created block together with other blocks of the blockchain via cryptography.

Optionally, another block of the blockchain is associated with another company in the network of companies.

Optionally, the other block of the blockchain is associated with an event in which the other company joins the network of companies.

Optionally, the other block of the blockchain is associated with an event in which the other company leaves the network of companies.

Optionally, the legal document comprises a non-disclosure agreement.

Optionally, the legal document is an agreement between the company and a provider or an owner of the electronic system.

Optionally, one or more of companies in the network of companies are third-party beneficiaries under the agreement.

Optionally, the processing unit is configured to communicate with a blockchain-service provider.

Optionally, the blockchain-service provider is Amazon Quantum Ledger Database (QLDB).

Optionally, the electronic system further includes an extractor configured to extract information from the signed legal document, provide the extracted information to the blockchain-service provider, and obtain the blockchain information, wherein the block of the blockchain is provided by the blockchain-service provider based on the extracted information.

Optionally, the electronic legal document provider is configured to interface with a document-service provider.

Optionally, the document-service provider is DocuSign.

Optionally, the electronic legal document provider is configured to obtain the signed legal document from the document-service provider.

Optionally, the electronic system further includes a non-transitory medium storing company information of the company.

Optionally, the electronic system further includes a non-transitory medium storing the blockchain information.

Optionally, the non-transitory medium is configured to store the blockchain information in association with company information of the company.

Optionally, wherein the electronic system is configured to obtain company information of the company, and wherein the company information comprises one or more of: a name of the company, an address of the company, a jurisdiction of the company, or contact information of the company.

Optionally, the blockchain information comprises one or more of: a block address, a digest, a digest tip address, or hash information.

Optionally, the electronic legal document provider is configured to electronically generate the legal document based on company information of the company.

Optionally, the blockchain is configured to implement, and/or to support, a fabric of confidentiality that comprises confidentiality obligations among companies in the network of companies.

Optionally, the signed legal document is secured in a blockchain ledger of the blockchain.

Optionally, the electronic system further includes a user-interface generator configured to provide a user-interface.

Optionally, the user-interface is configured to allow a user to enter company information of the company, and to provide the electronic signature for the legal document.

Optionally, the user-interface is also configured to allow a user to provide the subscription information for the company.

Optionally, the user-interface is configured to allow a user to view a list of companies in the network of companies.

Optionally, the user-interface is configured to allow a user to un-subscribe the company for the network of companies.

Optionally, the user-interface is configured to allow a user to enter document information regarding another signed legal document for authentication of the other signed legal document.

A method performed by an electronic system configured for creating and maintaining a network of companies having legal obligations with each other, includes: electronically providing a legal document; obtaining a signed legal document for a company, wherein the signed legal document is based on an electronic signature applied for the legal document; obtaining, by a subscription engine of the electronic system, subscription information for the company; registering, by the subscription engine of the electronic system, the company as a subscriber for the network of companies based on the subscription information; and obtaining, by a processing unit of the electronic system, blockchain information associated with a block of a blockchain, wherein the block of the blockchain is created based on the signed legal document after the company is registered as the subscriber for the network of companies.

Optionally, the processing unit is configured to interface with a blockchain engine configured to create the block of the blockchain, and to link the created block together with other blocks of the blockchain via cryptography.

Optionally, another block of the blockchain is associated with another company in the network of companies.

Optionally, the other block of the blockchain is associated with an event in which the other company joins the network of companies.

Optionally, the other block of the blockchain is associated with an event in which the other company leaves the network of companies.

Optionally, the legal document comprises a non-disclosure agreement.

Optionally, the legal document is an agreement between the company and a provider or an owner of the electronic system.

Optionally, one or more of companies in the network of companies are third-party beneficiaries under the agreement.

Optionally, the processing unit is configured to communicate with a blockchain-service provider.

Optionally, the blockchain-service provider is Amazon Quantum Ledger Database (QLDB).

Optionally, the method further includes: extracting, by an extractor of the electronic system, information from the signed legal document; providing the extracted information to the blockchain-service provider, and obtaining the blockchain information, wherein the block of the blockchain is provided by the blockchain-service provider based on the extracted information.

Optionally, the signed legal document is obtained via a communication interface of the electronic system, the communication interface configured to interface with a document-service provider.

Optionally, the document-service provider is DocuSign.

Optionally, the communication interface is a part of an electronic legal document provider of the electronic system.

Optionally, the method further includes storing company information of the company in a non-transitory medium of the electronic system.

Optionally, the method further includes storing the blockchain information in a non-transitory medium of the electronic system.

Optionally, the blockchain information is stored in the non-transitory medium in association with company information of the company.

Optionally, the method further comprises obtaining company information of the company, wherein the company information comprises one or more of: a name of the company, an address of the company, a jurisdiction of the company, or contact information of the company.

Optionally, the blockchain information comprises one or more of: a block address, a digest, a digest tip address, or hash information.

Optionally, the legal document is electronically generated based on company information of the company.

Optionally, the blockchain is configured to implement, and/or to support, a fabric of confidentiality that comprises confidentiality obligations among companies in the network of companies.

Optionally, the signed legal document is secured in a blockchain ledger of the blockchain.

Optionally, the method further includes providing a user-interface, by a user-interface generator of the electronic system.

Optionally, the user-interface is configured to allow a user to enter company information of the company, and to provide the electronic signature for the legal document.

Optionally, the user-interface is also configured to allow a user to provide the subscription information for the company.

Optionally, the user-interface is configured to allow a user to view a list of companies in the network of companies.

Optionally, the user-interface is configured to allow a user to un-subscribe the company for the network of companies.

Optionally, the user-interface is configured to allow a user to enter document information regarding another signed legal document for authentication of the other signed legal document.

A product includes one or more non-transitory media storing a set of instructions, wherein an execution of the instructions will cause a method to be performed by an electronic system configured for creating and maintaining a network of companies having legal obligations with each other, the method comprising: electronically providing a legal document; obtaining a signed legal document for a company, wherein the signed legal document is based on an electronic signature applied for the legal document; obtaining, by a subscription engine of the electronic system, subscription information for the company; registering, by the subscription engine of the electronic system, the company as a subscriber for the network of companies based on the subscription information; and obtaining, by a processing unit of the electronic system, blockchain information associated with a block of a blockchain, wherein the block of the blockchain is created based on the signed legal document after the company is registered as the subscriber for the network of companies.

Optionally, the processing unit is configured to interface with a blockchain engine configured to create the block of the blockchain, and to link the created block together with other blocks of the blockchain via cryptography.

Optionally, another block of the blockchain is associated with another company in the network of companies.

Optionally, the other block of the blockchain is associated with an event in which the other company joins the network of companies.

Optionally, the other block of the blockchain is associated with an event in which the other company leaves the network of companies.

Optionally, the legal document comprises a non-disclosure agreement.

Optionally, the legal document is an agreement between the company and a provider or an owner of the electronic system.

Optionally, one or more of companies in the network of companies are third-party beneficiaries under the agreement.

Optionally, the processing unit is configured to communicate with a blockchain-service provider.

Optionally, the blockchain-service provider is Amazon Quantum Ledger Database (QLDB).

Optionally, the method further comprises: extracting, by an extractor of the electronic system, information from the signed legal document; providing the extracted information to the blockchain-service provider, and obtaining the blockchain information, wherein the block of the blockchain is provided by the blockchain-service provider based on the extracted information.

Optionally, the signed legal document is obtained via a communication interface of the electronic system, the communication interface configured to interface with a document-service provider.

Optionally, the document-service provider is DocuSign.

Optionally, the communication interface is a part of an electronic legal document provider of the electronic system.

Optionally, the method further comprises storing company information of the company in a non-transitory medium of the electronic system.

Optionally, the method further comprises storing the blockchain information in a non-transitory medium of the electronic system.

Optionally, the blockchain information is stored in the non-transitory medium in association with company information of the company.

Optionally, the method further comprises obtaining company information of the company, wherein the company information comprises one or more of: a name of the company, an address of the company, a jurisdiction of the company, or contact information of the company.

Optionally, the blockchain information comprises one or more of: a block address, a digest, a digest tip address, or hash information.

Optionally, the legal document is electronically generated based on company information of the company.

Optionally, the blockchain is configured to implement, and/or to support, a fabric of confidentiality that comprises confidentiality obligations among companies in the network of companies.

Optionally, the signed legal document is secured in a blockchain ledger of the blockchain.

Optionally, the method further comprises providing a user-interface, by a user-interface generator of the electronic system.

Optionally, the user-interface is configured to allow a user to enter company information of the company, and to provide the electronic signature for the legal document.

Optionally, the user-interface is also configured to allow a user to provide the subscription information for the company.

Optionally, the user-interface is configured to allow a user to view a list of companies in the network of companies.

Optionally, the user-interface is configured to allow a user to un-subscribe the company for the network of companies.

Optionally, the user-interface is configured to allow a user to enter document information regarding another signed legal document for authentication of the other signed legal document.

Other features will be described in the detailed description.

### BRIEF DESCRIPTIONS OF THE DRAWINGS

The above and other features and advantages will become readily apparent to those skilled in the art by the following detailed description of exemplary embodiments thereof with reference to the attached drawings, in which:

FIG. 1 illustrates an example of a network of companies utilizing current non-disclosure agreement (NDA) system to protect confidential information.

FIG. 2 illustrates a fabric of confidentiality provided using electronic system and method descried herein.

FIGS. 3A and 3B illustrate comparison between current NDA system and new NDA system.

FIG. 4 illustrates an example of an electronic system configured to enable exchange of information among companies in a network of companies via a legal fabric.

FIGS. 5A-5F illustrate an example of a user-interface provided by a user-interface generator of the electronic system of FIG. 4.

FIGS. 6A-6J illustrate an example of a legal document provided by the electronic system of FIG. 4.

FIGS. 7A-7B illustrate an example of a subscription agreement provided by the electronic system of FIG. 4.

FIG. 8 illustrates a fabric membership lifecycle.

FIG. 9 illustrates properties of a legal fabric for confidential information protection.

FIG. 10 illustrates a flow diagram concerning a legal fabric.

FIG. 11 illustrates a method performed by the electronic system of FIG. 4.

FIGS. 12A-12J illustrates examples of information that may be provided by the electronic system of FIG. 4.

FIG. 13 illustrates an example of a specialized processing system.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

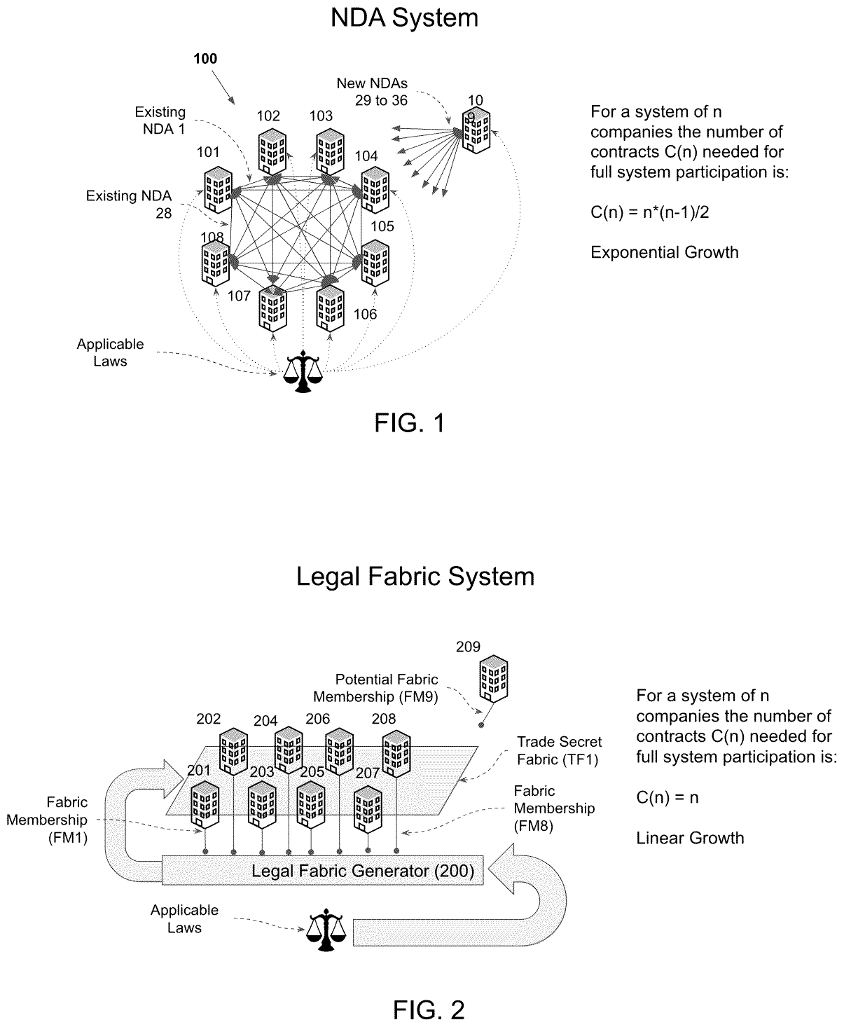

FIG. 1 illustrates an exemplary network 100 of companies 101-108 utilizing NDAs for the exchange of confidential information. The number of NDAs that have to be negotiated, signed, and maintained between a system of n companies equals n*(n−1)/2 (exponential growth). Each of the companies 101-108 must negotiate and enter into an NDA with every other company. Each of the companies 101-108 is evaluating applicable laws for every NDA entered into. A total of 28 NDAs (NDA 1 to 28) are necessary for a system of 8 companies. The exchange of confidential information in FIG. 1 is governed by the individual NDAs. A new entrant (company 109) into the network 100 must negotiate 8 NDAs (NDAs 29 to 36) to fully participate in the system bringing the total to 36 NDAs for a system of 9 companies.

FIG. 2 illustrates an exemplary legal fabric for purposes of allowing a network of companies to exchange confidential information (e.g., trade secrets). The legal fabric generator 200 utilizes applicable laws and membership rules (embedded in fabric memberships) to generate a legal fabric 250. The number of memberships necessary for full legal fabric system participation by n companies equals n (linear growth). The companies 201-208 join the legal fabric 250 through memberships FM1-FM8. The companies 201-208 use the legal fabric 250, and not a direct contract such as an NDA, to exchange confidential information. A total of only 8 memberships are necessary for a system of 8 companies (vs. 28 for the NDA system of FIG. 1). A new entrant (company 209) into the system needs to only evaluate one agreement, the fabric membership FM9. Thus, the system of FIG. 2 is advantageous over that of FIG. 1.

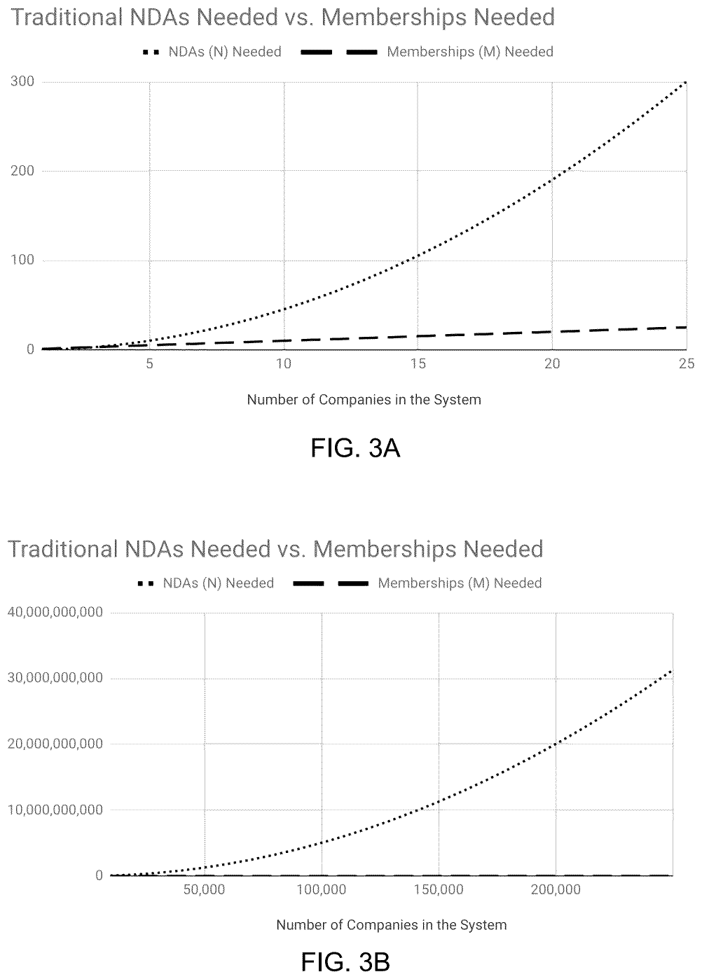

FIGS. 3A-3B illustrate a reduction in complexity, measured by the number of agreements required for full network participation, between a traditional NDA system (like that shown in FIG. 1) and the legal fabric system (like that shown in FIG. 2). FIGS. 3A and 3B only differ in the scale used. FIG. 3A illustrates the number of NDAs (dotted line) vs. fabric memberships (dashed line) needed for systems between 2 and 25 companies. It shows exponential growth of NDAs needed vs. linear growth of memberships. FIG. 3B illustrates the same for systems between 2 and 250,000 companies. In FIG. 3B, the dashed line of memberships needed is almost parallel to the x-axis while the number of NDAs needed exceeds 10,000,000,000 for 150,000 companies. As shown in these figures, the NDA system of FIG. 2 is advantageous over that of FIG. 1 because it offers significant saving in time and resources to enable a network of companies to exchange confidential information through the legal fabric provided by the legal fabric generator 200.

### Example of an Electronic System

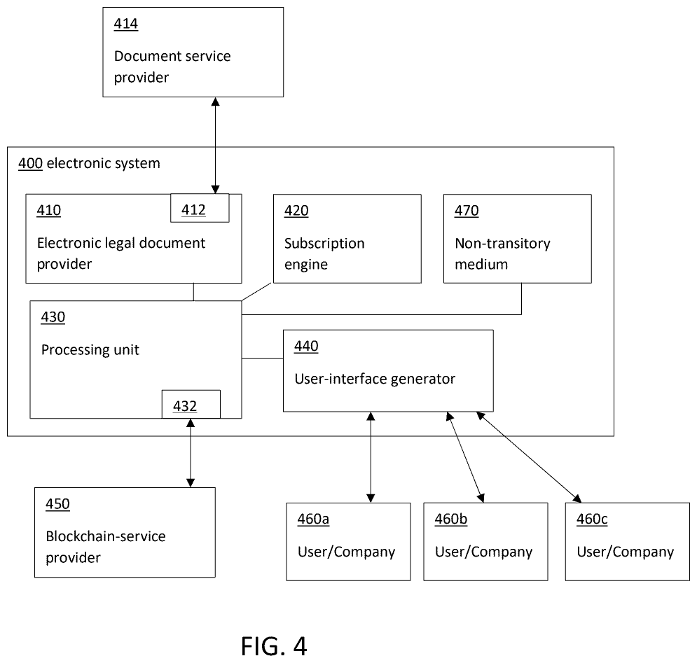

FIG. 4 illustrates an example of an electronic system 400 configured to create and maintain a legal fabric for a network of companies having legal obligations with each other. In some cases, the legal fabric provided by the electronic system 400 allows the companies in the network of companies to exchange confidential information with each other. The electronic system 400 includes an electronic legal document provider 410, a subscription engine 420, a processing unit 430, and a user-interface generator 440.

The legal document provider 410 is configured to electronically provide a legal document, and obtain a signed legal document for the company, wherein the signed legal document is based on an electronic signature applied for the legal document. In some cases, the legal document provider 410 may also optionally be configured to obtain company information of a company. By means of non-limiting examples, the company information may include one or more of: a name of the company, an address of the company, a jurisdiction of the company, or contact information of the company. In some cases, the legal document provider 410 may be configured to generate the legal document based on the company information of the company. Also, in some cases, the legal document provider 410 may be a part of a website or an application configured to provide a user interface for interaction with a user.

In the illustrated embodiments, the electronic legal document provider 410 comprises a communication interface 412 configured to interface with a document-service provider 414 (e.g. DocuSign). In such cases, the communication interface 412 is configured to obtain the signed legal document from the document-service provider 414. In other cases, the electronic legal document provider 410 may not include the communication interface 412, and the communication interface 412 may be a part of the electronic system 400 (e.g., a part of another component, such as a part of the processing unit 430). In further cases, the electronic system 400 may not include the communication interface 412. In such cases, the electronic system 400 is configured to obtain electronic signature to create the signed legal document without utilizing the document-service provider 414.

The subscription engine 420 is configured to obtain subscription information for the company, and register the company as a subscriber for the network of companies based on the subscription information. In some cases, the subscription engine 420 may be implemented as one or more non-transitory media. In such cases, the registering of the company as a subscriber for the network of companies may be performed by the subscription engine 420 storing the company information (e.g., name of the company) using a data structure that associates the company information with the subscription information. By means of non-limiting examples, subscription information may include one or more of: subscription confirmation, subscription date, membership identification, etc. In other embodiments, the subscription engine 420 may include some processing functionalities beyond the storage of subscription information. For example, in other embodiments, the subscription engine 420 may include a subscription management tool that allows a user of the electronic system 400 to maintain and manage subscription information for the member companies in the network.

The processing unit 430 is configured to obtain blockchain information associated with a block of a blockchain, wherein the block of the blockchain is created based on the signed legal document after the company is registered as the subscriber for the network of companies. At some point in time, the company may decide to leave the network of companies, and may un-subscribe as a member of the network using the electronic system 400. In such cases, a new block will be generated for the blockchain based on the company de-registering as the subscriber, and the processing unit 430 will obtain blockchain information associated with the new block of the blockchain. In the blockchain, another block of the blockchain may be associated with another company in the network of companies. For example, the other block of the blockchain may be associated with an event in which the other company joins the network of companies. As another example, the other block of the blockchain is associated with an event in which the other company leaves the network of companies. Thus, the blockchain stores a sequence of entries representing companies joining the network and companies leaving the network. In some cases, the blockchain is an append-only, immutable journal that stores a sequence of cryptographically verifiable entry of each change made. The changes are chained together as blocks, wherein each block may indicate a company joining the network or a company leaving the network.

In the illustrated embodiments, the processing unit 430 of the electronic system 400 is configured to interface with a blockchain-service provider 450. For example, the blockchain-service provider 450 may be Amazon Quantum Ledger Database (QLDB). QLDB is a purpose-built ledger database that provides a complete and cryptographically verifiable history of changes made to application data. QLDB is a fully managed ledger database that provides a transparent, immutable, and cryptographically verifiable transaction log. With QLDB, the history of changes to data is immutable-it can't be overwritten or altered in place. Using cryptography, one can verify that there have been no unintended changes to the application's data. QLDB uses an immutable transactional log, known as a journal.

The electronic system 400 (e.g., the processing unit 430 of the electronic system 400) is configured to provide certain information to the blockchain-service provider 450. For example, the processing unit 430 may provide company information of the company 460 joining the network, company information of the company 460 leaving the network, date on which the company 460 joins the network, date on which the company 460 leaves the network, information regarding scope of agreement signed by the company 460, etc., or any combination of the foregoing. The blockchain-service provider 450 generates a new block of the blockchain based on the information, and provides blockchain information regarding the generated new block. The processing unit 430 of the electronic system 400 obtains the blockchain information via the communication interface 432. By means of non-limiting examples, the blockchain information may include one or more of: a block address, a digest, a digest tip address, hash information, etc. In some cases, the processing unit 430 may include an extractor configured to extract information in one or more agreements (signed legal document, subscription agreement, etc.) signed by the company 460, and may provide such information to the blockchain-service provider 450, so that the blockchain-service provider 450 can generate a new block for the blockchain based on the extracted information. In other cases, the processing unit 430 may obtain information from the subscription engine 420 and/or from a non-transitory medium (e.g., the non-transitory medium 470 described herein), and may provide such information to the blockchain-service provider 450, so that the blockchain-service provider 450 can generate a new block for the blockchain based on the information.

In other cases, the communication interface 432 of the processing unit 430 may be configured to interface with a blockchain engine configured to create the block of the blockchain, and to link the created block together with other blocks of the blockchain via cryptography.

The user-interface generator 440 is configured to provide a user-interface that allows users from respective companies 460 to interact with the electronic system 400. As shown in the example of FIG. 4, three users for three different respective companies 460a-460c are using the user-interface provided by the user-interface generator 440. It should be understood that in other cases, there may be more than three users or fewer than three users. In one implementation, the user-interface generator 440 may be a graphic generator configured to generate the user-interface. In another implementation, the user-interface generator 440 may be an application, or a part of an application (e.g., running in a local computer or in a cloud computing system) that is configured to provide the user-interface. For example, the user-interface generator 440 may be a part of a website application configured to provide a website that includes the user interface. In other cases, the user-interface generator 440 may be configured to provide the user-interface indirectly. For example, the user-interface generator 440 may communicate with a third-party, and may provide information regarding the user-interface (e.g., website application, html data, etc.) for allowing the third-party to generate a website that functions as the user-interface.

The user interface provided by the user-interface generator 440 may be configured to allow a user associated with a company 460 to enter company information of the company in order to have the company 460 join the network of companies. The user interface may also be configured to allow the user to de-register (un-subscribe) to thereby have the company 460 leave the network of companies.

In some cases, the user-interface may be configured to allow a user to provide an electronic signature for a legal document in order to sign the legal document on behalf of the company 460. In the illustrated embodiments, such may be required by the electronic system 400 in order to have the company 460 join the network of companies. Alternatively or additionally, the user-interface may be configured to allow the user to provide the subscription information for the company. Alternatively or additionally, the user-interface may be configured to allow a user to view a list of companies in the network of companies. Alternatively or additionally, the user-interface may be configured to allow a user to enter document information regarding another signed legal document by another company for authentication of the other signed legal document.

As shown in FIG. 4, the electronic system 400 further includes a non-transitory medium 470 storing the company information of the company 460, blockchain information provided by the blockchain-service provider 450, list of companies 460 in the network, activity information regarding activities of the companies 460, or any combination of the foregoing. By means of non-limiting examples, activity information may include date of a company joining the network, date of a company leaving the network, dates in which the company has logged into the electronic system 400, activities performed by the company using the user interface provided by the user-interface generator 440, etc., or any combination of the foregoing. In some cases, the non-transitory medium 460 may be configured to store the blockchain information in association with the company information. It should be noted that the non-transitory medium 470 is not limited to being a single storage device, and that the non-transitory medium 470 may be implemented using multiple storage devices.

It should be noted that the electronic system 400 is not limited to having the configuration shown in FIG. 4, and that the electronic system 400 may have other configurations in other embodiments. For example, in other embodiments, the processing unit 430 of the electronic system 400 may not communicate with a blockchain-service provider 450. Instead, the processing unit 430 may include a blockchain module configured to generate blocks of the blockchain. In other embodiments, the processing unit 430 may include an authentication module configured to provide authenticate transactions (company joining the network, company exiting the network, etc.) of the companies in the network.

Also, in other embodiments, the electronic legal document provider 410 may include functions of the document service provider 414. In such cases, the electronic legal document provider 410 is not required to have the communication interface 412, and does not communicate with the document service provider 414. For example, in some cases, the electronic legal document provider 410 may be a DocuSign module. In other embodiments, the electronic legal document provider 410 may simply be a non-transitory medium, or a storage unit in a non-transitory medium, storing electronic versions of the documents to be executed by each joining company. In such cases, the electronic legal document provider 410 does not provide any DocuSign function.

In addition, in further embodiments, the electronic legal document provider 410, the subscription engine 420, and the non-transitory medium 470, may be integrated. For example, these components of the electronic system 400 may be implemented using one or more storage units of one or more storage devices (e.g., servers, databases, etc.).

In still further embodiments, the electronic legal document provider 410, the subscription engine 420, the user-interface generator 440, or any combination of the foregoing, may be integrated with the processing unit 430, or may be implemented as a part of the processing unit 430.

In other embodiments, the electronic legal document provider 410 may be implemented as a part of the processing unit 430, as well as a part of the non-transitory medium 470. For example, the electronic legal document provider 410 may include a document processing module located in the processing unit 430, and may include a storage unit in the non-transitory medium 470 storing documents and other document processing information for the operation of the document processing module.

Similarly, in other embodiments, the user-interface generator 440 may be implemented as a part of the processing unit 430, as well as a part of the non-transitory medium 470. For example, the user-interface generator 440 may include a graphic generation module located in the processing unit 430, and may include a storage unit in the non-transitory medium 470 storing information for the provision of the user interface.

In further embodiments, the processing unit 430, the user-interface generator 440, and the electronic legal document provider 410 may be implemented as parts of a website. In such cases, the processing unit 430 is configured to process information transmitted to the website, and to process information generated by the website. The user-interface generator 440 may be a graphic module that includes coding for generating the graphics for the website. The electronic legal document provider 410 may be a module in the website that provides document processing functions (e.g., retrieving of a document, document viewing, document signing, etc.).

A method performed by the electronic system 400 will now be described. The electronic system 400 of FIG. 4 may be utilized by a network of companies 460 to create a legal fabric. During use, a user (e.g., an administrator, an owner, etc.) associated with a company 460 may register the company 460 as a subscriber (member) of the network using a user interface provided by the user-interface generator 440 of the electronic system 400. In one implementation, the user may open a web browser and go to a website of the provider of the electronic system 400. The website contains a user interface from which the user may enter information about the company 460. As a part of the subscription process, the electronic system 400 may require the company 460 to sign one or more agreements. In the illustrated example, the user interface provided by the user-interface generator 440 is configured to present a legal document (fabric of confidentiality agreement) and a subscription agreement for execution by the company 460. The legal document imposes certain legal obligations for the company 460, and governs the behavior of the company 460 in the network of companies. In the illustrated embodiments, the legal document is an agreement between the joining company and the owner/provider of the electronic system 400, wherein the joining company agrees to keep information to be received from other member companies in the network confidential. Thus, the other member companies are third-party beneficiaries under the legal document. The subscription agreement is an agreement between the company 460 and the provider of the electronic system 400. In other embodiments, the user interface may provide other types of legal documents for execution by the companies 460. After the company 460 has signed the agreements, the processing unit 430 then provides certain information regarding the newly joining company 460 to the blockchain-service provider 450. In some embodiments, such information may include company information of the company and information regarding the signed agreements. In one implementation, the information regarding the signed agreements may be one or more hash values generated by the electronic system 400 based on the signed agreements. After the blockchain-service provider 450 receives such information, the blockchain-service provider 450 generates a new block for the blockchain, and provides blockchain information to the processing unit 430 of the electronic system 400. The blockchain information may be any information regarding the newly generated block, such as a confirmation that a new block has been generated. After the new block is generated, the company 460 then becomes a member (e.g., subscriber) of the network of companies. In the illustrate example, because the legal document signed by the company 460 is a fabric of confidentiality agreement, and because other companies 460 in the network have signed the same respective agreements, the companies 460 in the network may exchange confidentiality information governed by such signed agreements.

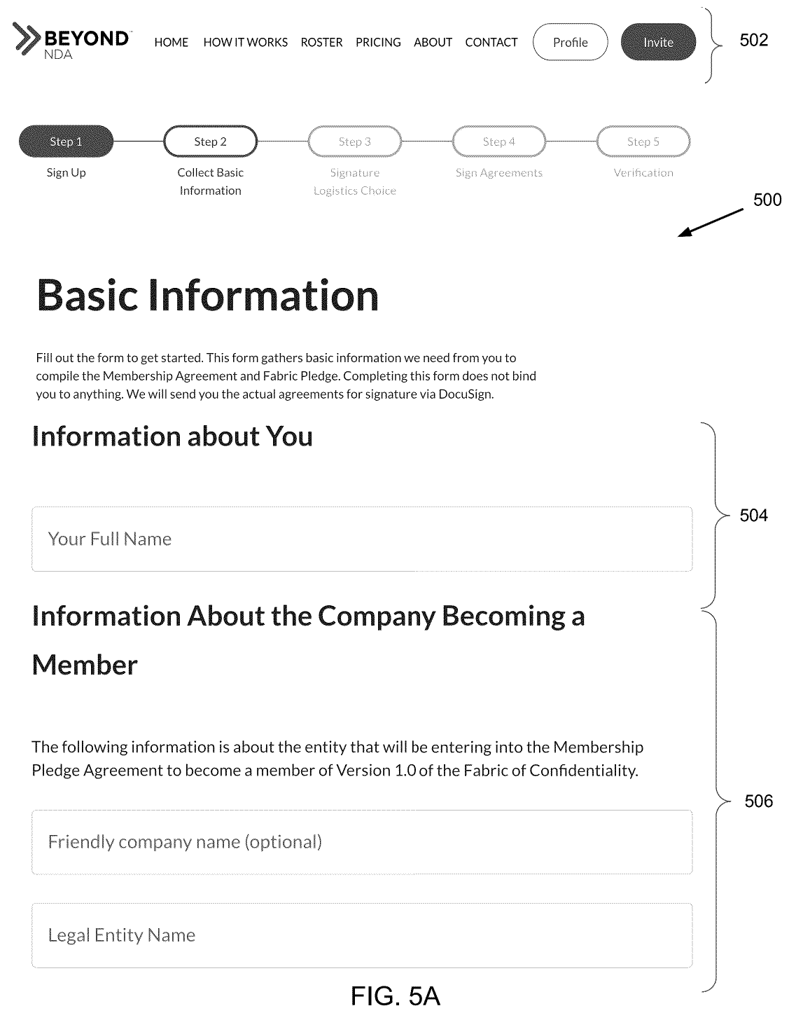

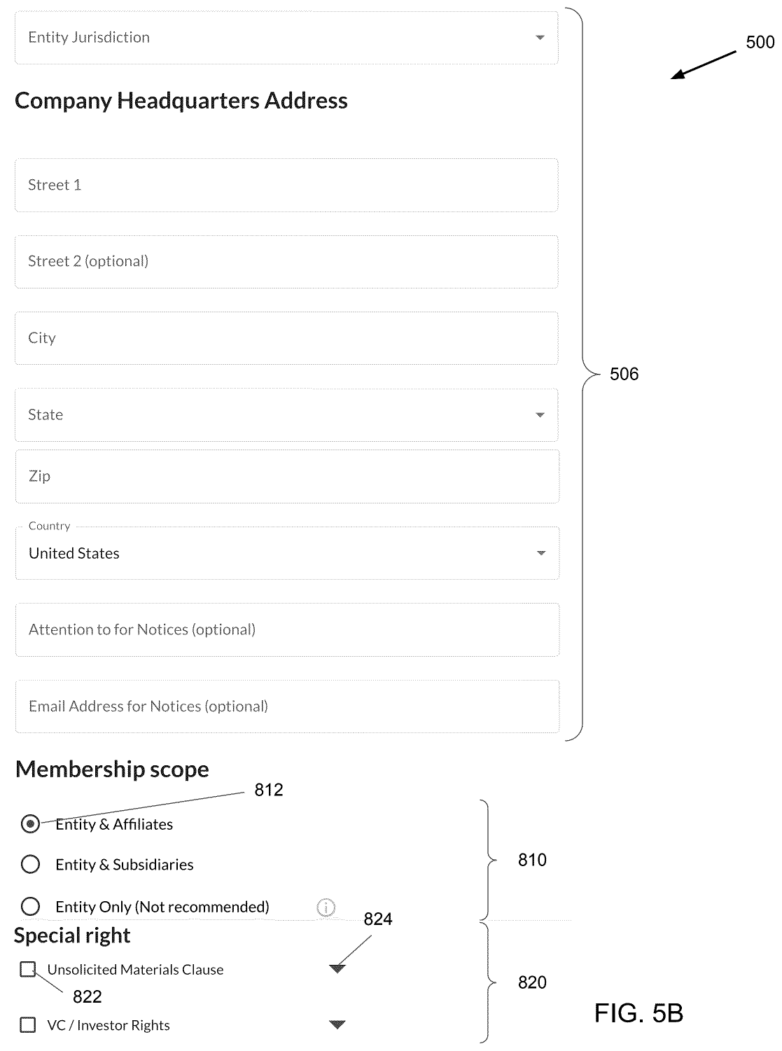

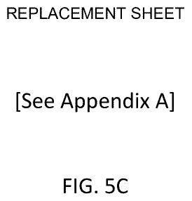

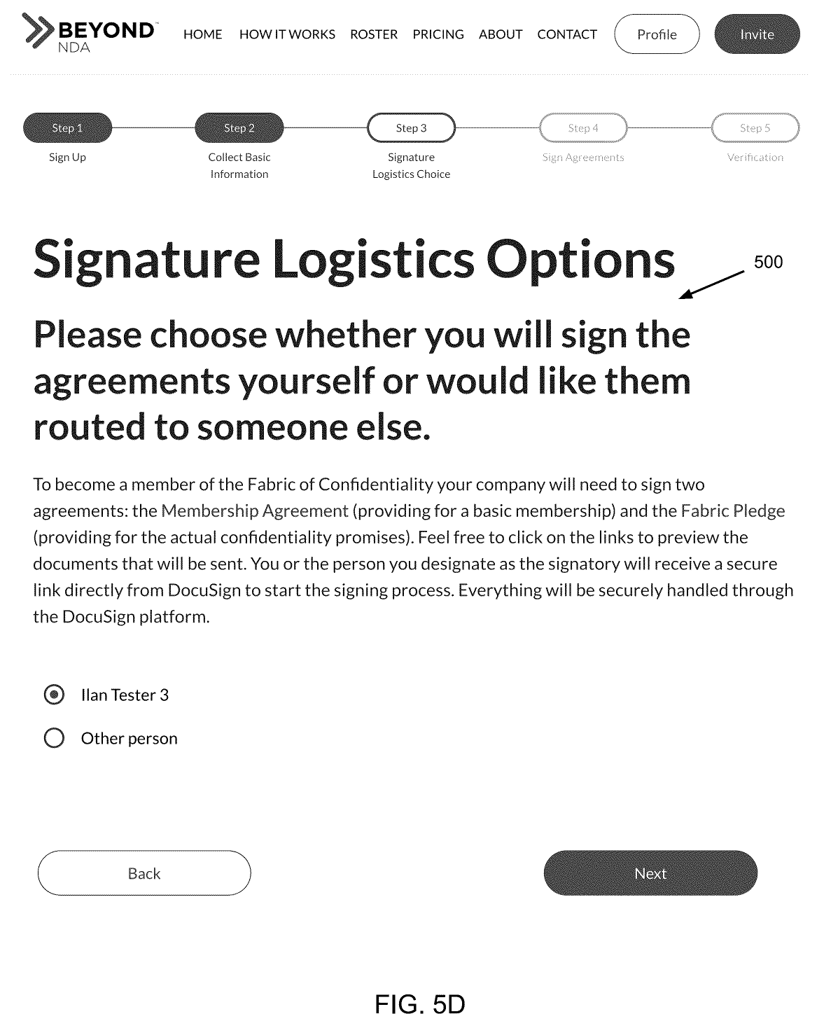

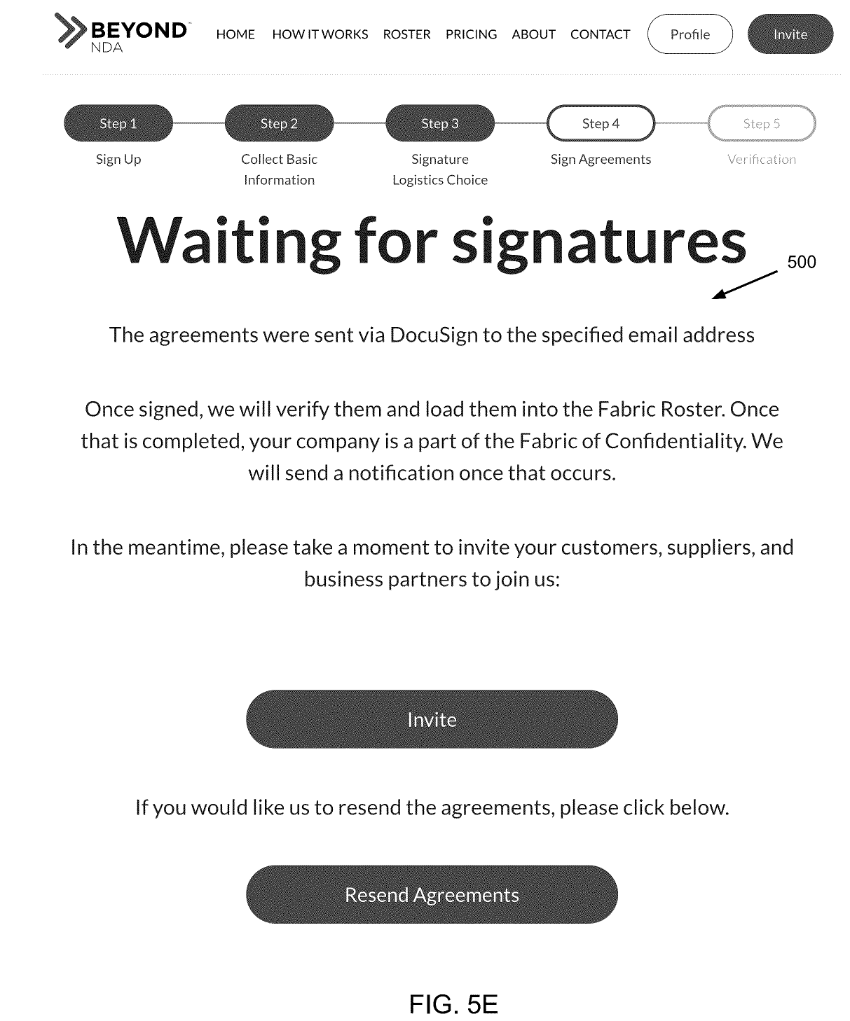

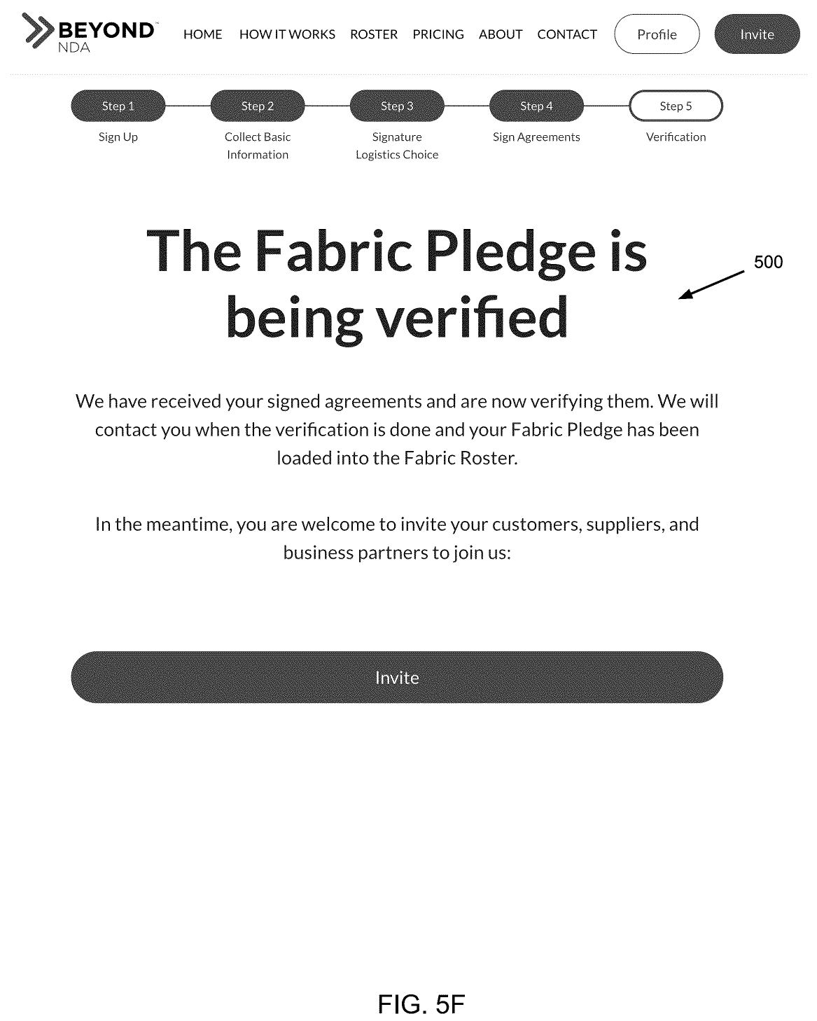

As discussed, the user-interface generator 440 is configured to directly or indirectly provide a user-interface, which allows a user associated with a company to provide certain required information in order to have the company join the network of companies operating under the legal fabric provided by the electronic system 400. FIGS. 5A-5F illustrate an example of the user interface 500 that may be provided by the user-interface generator 440 of the electronic system 400. A company may access the user interface 500 provided by the user-interface generator 440 of the electronic system 400. Such may be accomplished by a user (e.g., owner of the company, administrator of the company, etc.) associated with the company accessing a website having the user interface provided by the electronic system 400. As shown in FIG. 5A, the user interface 500 includes a status field 502 indicating a status of the subscription process when the user goes through the different steps of the subscription process.

As the first step of the subscription process, the user interface 500 asks the user to enter some basic information concerning the user and the joining company. In particular, the user interface 500 includes a user information section 504 in which the user can enter the user's name.

The user interface 500 also includes a company information section 506, that allows the user to enter company information for the company. Under the company information section 506, the user associated with the company may enter some basic information about the company, such as name of the user, legal name of the company, the jurisdiction in which the company is located, address of the company, contact (e.g., phone, email address, etc.) for the company, etc.

As shown in FIG. 5B, the user interface 500 also includes a “membership scope” section 810, which allows the company to select whether it wants the legal agreement to cover the company only, to cover the company and its subsidiaries, or to cover the company and its subsidiaries and affiliates. The user associated with the joining company may select one of the options by selectin the object 812 next to the corresponding option. Thus, when a company enrolls, the company may choose whether and to extent the enrolment to its subsidiaries and affiliates. In an ideal situation, it would be best if all subsidiaries of a company are enrolled. For example, if the joining company operates under a friendly name (say “ACME”) even though people may work for different legal entities (say “ACME Steel, Inc.” and “ACME Cement, Inc.”), then all ACME entities are encouraged to be enrolled. This has the benefit of allowing the companies in the network to interact for ordinary course of business discussions without uncertainty as to whether they are dealing with the specific enrolled entity or not.

The user interface 500 also includes a “special right” section 820 which allows the company to decide whether it wants to have an “unsolicited materials clause” and/or “VC/Investor Rights” in the agreement to be generated for execution by the company. The user associated with the company may select the boxes 822 next to these items. If the user wants to learn more about the “unsolicited material clause” and/or the “VC/Investor Rights”, the user may select the arrows 824 next to these items. FIG. 5C shows the user interface 500 providing some details about the “unsolicited material clause” and the “VC/Investor Rights” in response to the user selecting the arrows 824.

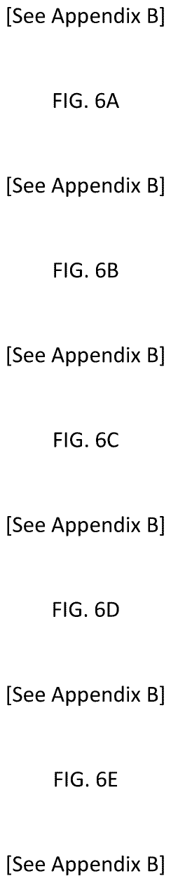

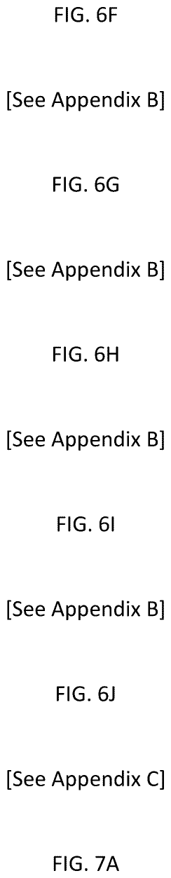

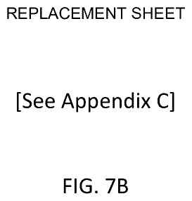

As shown in FIG. 5D, after the company information has been provided by the user, the user interface 500 then prompts the user to sign a legal document (e.g., “Fabric Pledge”), and a subscription agreement (e.g., “Membership Agreement”). If the user clicks on the item “Fabric Pledge”, the user interface 500 then presents a legal document for the user to review and to sign. If the user clicks on the item ‘Membership Agreement”, the user interface 500 then presents a subscription agreement 700 for the user to review and to sign. FIGS. 6A-6J illustrate an example of a legal document 600 that may be presented by the user interface 500 during the subscription process. In the illustrated embodiments, the legal document 600 is an agreement between the company (subscriber) and the owner/provider of the electronic system 400, wherein the company agrees to keep information provided by other member companies confidential. Thus, all other member companies are third-party beneficiaries with respect to the agreement entered between the company and the owner/provider of the electronic system 400. FIGS. 7A-7B illustrate an example of a subscription agreement 700 hat may be provided by the user interface 500. The subscription agreement 700 is an agreement between the company (subscriber) and the owner/provider of the electronic system 400. The subscription agreement 700 sets forth the subscription terms agreed upon by the company and the owner/provider of the electronic system 400.

As shown in FIG. 6A, the legal document 600 includes “The Member” section that identifies the name of the member (the company name) and other information regarding the member, such as address of the company and contact information. In some cases, the information in “The Member” section may be automatically filled in by the electronic legal document provider 410 of the electronic system 400 based on the membership information provided by the user via the user interface 500. Alternatively, the legal document 600 provided by the user interface 500 may have the “The Member” section in blank form. In such cases, the user may type in the required information in the legal document 600.

As shown in FIG. 6A, the legal document 600 also includes a “The Member's Elections” section. This allows the member (company 460) to select the scope of the legal agreement to be signed by the joining company.

Returning to FIG. 5D, if the user associated with the joining company selects the object “Next” in the user interface 500, it indicates to the electronic system 400 that the user wants to sign the legal document 600 and the subscription agreement 700. In such cases, the electronic system 400 will arrange the legal document 600 and the subscription agreement 700 using the document service provider 414 (e.g., DocuSign) so the user can electronic sign these documents, and the user interface 500 will inform the user that these documents have been sent to the user's address for execution by electronic signatures (FIG. 5E).

After the user has signed both the legal document 600 and the subscription agreement 700, the user interface 500 then informs the user associated with the company that the executed documents are being verified (FIG. 5F). In some embodiments, during the verification phase, the name of the person associated with the company may be verified to confirm that such name exists. Alternatively or additionally, the contact (e.g., phone and/or email) of the person associated with the company is valid. Alternatively or additionally, the address and jurisdiction of the company may be checked. In one implementation, the verification of the various information during the verification phase may be performed by a person who works for the owner/provider of the electronic system 400. In another implementation, the electronic system 400 may send the desired information to be verified to a third-party service provider, which then checks and verifies the various information. The third-party service provider may then send the verification result back to the electronic system 400.

After the desired information regarding the company has been verified, the processing unit 430 of the electronic system 400 then provides certain information regarding the joining event for the company to the blockchain-service provider 450. By means of non-limiting examples, the information may include company information (e.g., name, address, etc.) of the company, joining time of the company, hash value(s) of the documents signed by the company, or any combination of the foregoing. To obtain the hash value(s) of the documents signed by the company, the processing unit 430 may include a hash generator configured to obtain the signed documents, and to generate hash value(s) based on the signed documents. In one implementation, the signed documents may be obtained from the document service provider 414 (e.g., DocuSign). Alternatively, the signed documents may be retrieved by the hash generator from the subscription engine 420 and/or from the non-transitory medium 470. After the blockchain-service provider 450 obtains the information from the processing unit 430, the blockchain-service provider 450 then generates a block of a blockchain based on the information. The generated block secures the signed documents in a blockchain ledger of the blockchain. The blockchain-service provider 450 also informs the processing unit 430 after the block has been generated. For example, the blockchain-service provider 450 may transmit a confirmation to the processing unit 430 indicating that a block of the blockchain has been successfully generated. The blockchain-service provider 450 may also transmit information regarding the block and/or the blockchain to the processing unit 430 of the electronic system 400.

After the block of the blockchain documenting the joining of the company has been created, the company then becomes a subscriber and successfully joins the network of companies governed by the legal fabric provided by the electronic system 400. In some cases, the information about the company, the joining time of the company, copies of the signed agreements signed by the company, information (e.g., hash) regarding the signed agreements, or any combination of the foregoing, may be stored in the subscription engine 420 and/or the non-transitory medium 470 of the electronic system 400. Alternatively or additionally, the information about the company, the joining time of the company, copies of the signed agreements signed by the company, information (e.g., hash) regarding the signed agreements, or any combination of the foregoing, may be stored in a database of the blockchain-service provider 450. The location of the storage of such information may constitute a fabric roster, from which such information may be accessed by user of the electronic system 400.

As shown in the above example, the electronic system 400 secures each company's signed agreement (the Pledge) in a blockchain ledger. The blockchain is cryptographically secure and provides for an immutable ledger. The user interface provided by the electronic system 400 may include a “members-only” area, which provides member companies a real-time view of the current membership state of all member companies in the network. This is called the ‘Roster’. Member companies can also use the user interface of the electronic system 400 to audit the actual blockchain ledger to verify a member's Pledge at any time. In some embodiments, the signed PDF of every member's Pledge may be double-authenticated. For example, each signed PDF of a member's Pledge may be authenticated by the cryptographic hashes inherent in the blockchain, and also by the electronic signature on the Pledge PDF itself.

In the above embodiments, the legal document (the Pledge) 600 is a non-disclosure agreement. However, the legal document 600 is not limited to it being a non-disclosure agreement, and may be any legal instrument that achieves one or more legal effects in other embodiments. By means of non-limiting examples, the legal document 600 may be an open-source agreement, a sales contract, a licensing agreement, etc.

In addition, the electronic system 400 is not limited to providing one legal fabric, and may provide multiple legal fabrics. For example, the electronic system 400 may provide a legal fabric specific for a certain type of information, for example a first legal fabric for exchange of confidential information, and a second legal fabric for exchange of trade secrets. Furthermore, the electronic system 400 may in some cases create sub-fabrics providing specific rights or duties to members of the sub-fabric. For example, the electronic system 400 may create a sub-fabric for regulated entities that allows disclosures to a regulator without a need of notification. As another example, the electronic system 400 may create a sub-fabric for facilitating multi-entity sharing arrangements under special rules, which may be stricter or looser than those imposed by the legal agreement (the pledge) associated with the current legal fabric. As a further example, the electronic system 400 may create a sub-fabric for groups or circles of members within the current legal fabric, wherein the groups/circles of members may have decided to form a smaller circle within the current legal fabric.

Also, in the above embodiments, each legal document 600 is an agreement between the company and a provider/owner of the electronic system 400. Under such agreement, one or more companies in the network of companies are third-party beneficiaries. In particular, each legal document 600 executed by a company is an agreement between that company and the provider/owner of the electronic system 700, wherein the company promises to protect confidential information of other companies in the network of companies. In other embodiments, one or more of the companies in the network of companies may not be third-party beneficiaries under the agreement.

In addition, in the above embodiments, blockchain technology is configured to implement, and/or to support, a fabric of confidentiality that comprises confidentiality obligations among companies in the network of companies. In other embodiments, the electronic system 400 may not utilize blockchain technology, and may utilize other types of technology to secure events (e.g., company joining the network, companying exiting the network) affecting the fabric of confidentiality, or any other types of legal fabric provided by the electronic system 400.

The electronic system 400 described herein is advantageous because it provides a legal fabric that allows a member company in a network to exchange confidential information with other companies in the network without requiring the member company to evaluate and to sign multiple non-disclosure agreements (NDA) with the respective companies. All of the signed agreements (Pledges) by the respective member companies collectively create a mutual non-disclosure arrangement, which is the legal fabric (specifically, the Fabric of Confidentiality in the example). In short, it is as if each member had an NDA with every other member, without needing to sign individual NDAs between members. The electronic system 400 makes it easy to weave together as many companies as possible into the Fabric of Confidentiality. The Fabric of Confidentiality is balanced and it does not favor the discloser or the recipient. Under this arrangement, companies are able to have baseline expectations of trust and fairness when dealing with each other without needing lawyers and negotiations. The provides tremendous saving in time and costs, and therefore, the electronic system 400 has significant utility and impact in the real world.

In addition, the electronic system 400 is advantageous because by securing the companies' signed agreements (pledges) in the blockchain ledger, the agreements signed by the companies can be authenticated and verifiable, and may be used as evidence in court. If a company in the network wants to check whether there is an NDA agreement in place before providing confidential information to a receiving company, the company simply needs to use the electronic system 400 to check to see if the receiving company is within the network of companies under the legal fabric provided by the electronic system 400. This obviates the need for the company to hire a lawyer to draft a separate agreement only for the exchange between the company and the receiving company. Also, the signed agreements may be easily accessed and retrieved using the electronic system 400 when needed. In the real world, a company may execute hundreds or even thousands of NDAs over the years. Sometimes, this type of documents can get lost, and it may not be easy to find and to retrieve any specific NDA.

It should be noted that the electronic system 400 is not limited to providing a legal fabric that assists companies in exchange of confidential information, and that the electronic system 400 may provide other types of legal fabrics in other embodiments. Thus, the above legal fabric generation technique may involve any laws (i.e., not limited to laws of confidentiality).

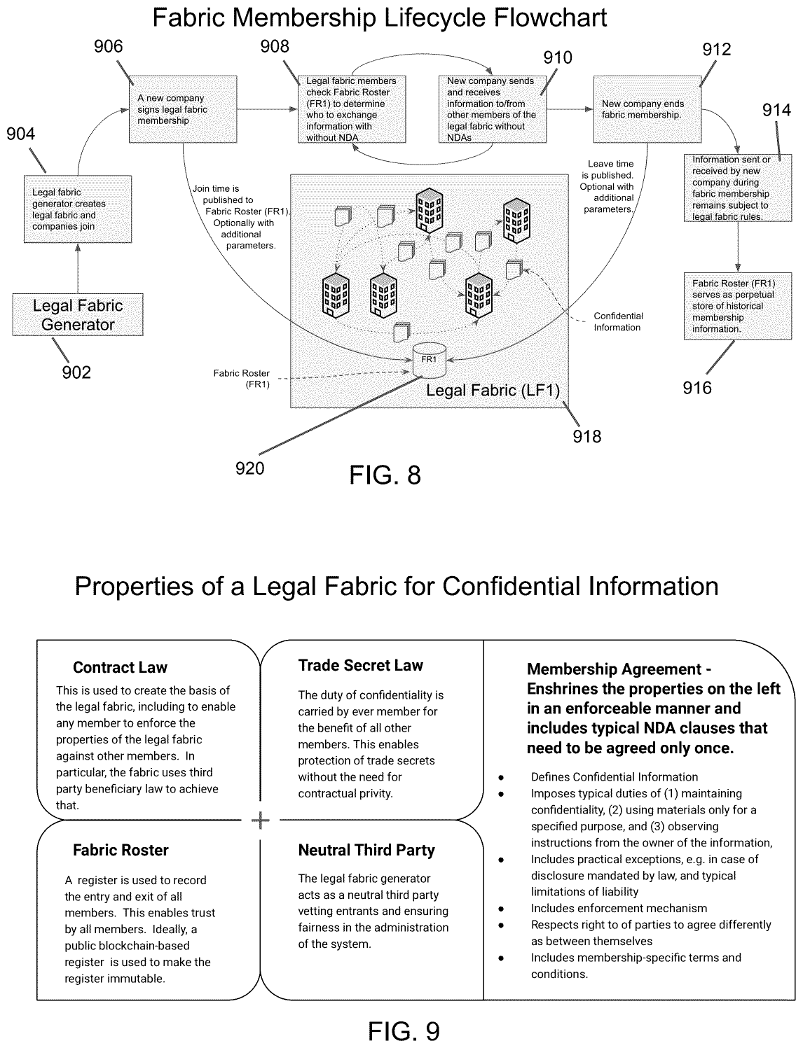

FIG. 8 illustrates an example of a fabric member lifecycle. First a legal fabric generator is provided (item 902). The legal fabric generator 902 may be implemented by the electronic system 400 describe herein. The legal fabric generator then generates a legal fabric 918 (item 904). A new company X that wants to join the legal fabric will then sign a legal fabric membership, e.g., the legal agreement 600 (item 906). The join time of the company X is then published to a fabric roster 920. During information exchange phase between companies, a legal fabric member (one of the companies in the network) may check the fabric roster 920 to determine whether a company is or is not a member of the legal fabric (item 908). The newly joined company X may send and receive information to/from other member companies of the legal fabric (item 910). At some point in time, the company X may end the fabric membership (item 912). When this happens, the leave (exit) time of the company X is published in the fabric roster 920. This allows other member companies to know that company X is no longer participating in the legal fabric, and therefore the remaining companies in the network should not exchange confidential information with company X. After company X ends the fabric membership, information sent or received by the company X during the fabric membership period remains subject to the legal fabric rules (item 914). Thus, company X is prevented from disclosing the confidential information after it ends the fabric membership. The fabric roster 920 serves as a perpetual store of historical membership information (item 916).

The fabric roster 920 may be one or more files, one or more databases, a computer system, or multiple computer systems acting in concert to constitute the fabric roster 920. In some embodiments, the fabric roster 920 may be one or more storage devices, such as the non-transitory medium 470 in the electronic system 400. In other embodiments, the fabric roster 920 may be implemented using the subscription engine 420. In further embodiments, the fabric roster 920 may be implemented using a combination of the subscription engine 420 and the non-transitory medium 470 in the electronic system 400. In some cases, the fabric roster 920 may store parameters of respective members, such as a legal name of a company, an address of the company, time when the company joins the legal fabric, time when the company leaves the legal fabric, or any combination of the foregoing. In some cases, the fabric roster 920 may optionally store additional information helpful to the administration of the legal fabric or to provide value-added services to members. Examples of additional information that may be stored in the fabric roster 920 include: (1) additional contact and other information; (2) whether or not subsidiaries or other affiliates are deemed members, (3) whether or not the member is joining one or more sub-fabrics, groups, or circles, (4) elections or parameters the member has chosen.

The legal fabric generator 902 (e.g., the electronic system 400) is advantageous because the fabric roster 920 it provides will always be accurate and complete (because the fabric roster 920 is updated whenever a member company joins or leaves the network). Thus, the content provided by the fabric roster 920 may be used as evidence in court. Also, the authenticity of the content in the fabric roster 920 is achieved using blockchain technology in the illustrated embodiments. This is possible due to the blockchain's inherent character of security and immutability. In other embodiments, the authenticity of the content in the fabric roster 920 may be accomplished using other security technologies that are non-blockchain technologies.

FIG. 9 illustrates some properties associated with the legal fabric created by the electronic system 400. As shown in the figure, the electronic system 400 utilized contract law as the basis of the legal fabric that governs the behavior of the companies in the network of companies. In the illustrated example, the contract (e.g., the agreement 600) signed by each company enables any member company in the network to enforce the properties of the legal fabric against other member companies, even though, each contract is an agreement between a member company and the owner/provider of the electronic system 400 (legal fabric generator). This is possible because the created legal fabric utilizes third party beneficiary law to impose the desired legal duties (e.g., duty to maintain exchanged information confidential) among the member companies. Thus, the duty of confidentiality is carried by ever member company for the benefit of all other member companies, while the legal fabric generator acts as a neutral party vetting entrants and ensuring fairness in the administration of the system. This enables protection of trade secrets and other confidential information while allowing the companies to exchange such information. In addition, the electronic system 400 provides a register to record the entry and exit of all member companies. This enables trust by all member companies. In the illustrated example, a blockchain-based register is utilized to make the register immutable. The blockchain-based register may be semi-private, public, or private. In other cases, a non-blockchain-based register may be used instead. It should be noted that the legal fabric created by the electronic system 400 is not limited to having all of the properties shown, and that the electronic system 400 may create other legal fabrics having only some of the properties shown, and/or having other properties that are different from those shown.

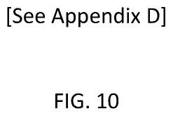

FIG. 10 illustrates a flow diagram concerning a legal fabric. To provide a legal fabric, the laws involved are first determined. In the case of the Fabric of Confidentiality, the desired properties of the exchange of information among companies, and how to create binding commitments among companies that do not have privity of contract are considered (Step 1). Then a membership agreement (e.g., the agreement 600) is created that addresses the needs of the law, and that governs the exchange of information among the companies (Step 2). The membership agreement serves as a binding commitment towards the other member companies, and is enforceable by other member companies despite there being no direct contractual relationship among the member companies. A register is provided by the electronic system 400 that allows anyone to determine who is or is not a member company of the legal fabric (Step 3). The register records the official state of membership agreement at any given moment in time, and is updated whenever a member company joins the network, or whenever a member company exits the network. Thus, the register is always up to date. The register may be secured using blockchain technology or other types of technology. At some point in time, a member company may want to exit from the network so that it is no longer operating under the legal fabric (Step 4). The electronic system 400 allows the company to easily exit from the network, and provides an orderly exit for the company. Due to the provision(s) in the membership agreement, despite a company exiting the network, the exiting company is still under the obligation to protect the information that it received during the membership period, and the remaining member companies in the network is still under the obligation to protect the information they received from the exiting company during the membership period. In some cases, if the structure of the legal fabric is desired to be updated, such can be achieved with unanimous consent of the member companies in the network (Step 5). The electronic system 400 provides an easy way to update the legal fabric. For example, in some cases, if the member companies unanimously agree to certain change(s) in the legal agreement (the Pledge), a new version of the legal agreement may be provided by the electronic system 400. The electronic system 400 may also provide information regarding this new version of the legal agreement to the blockchain-service provider 450, which then generates a block of the blockchain documenting the implementation of the new version of the legal agreement. This effectively modifies the legal fabric. In some cases, a subset of the member companies in the network may decide to migrate to a new legal fabric. In such cases, the electronic system 400 will treat these member companies as exiting the current legal fabric, and as joining a new legal fabric. The electronic system 400 may create multiple legal fabrics in some embodiments. A company may be a member company of one or more legal fabrics provided by the electronic system 400.

### Method

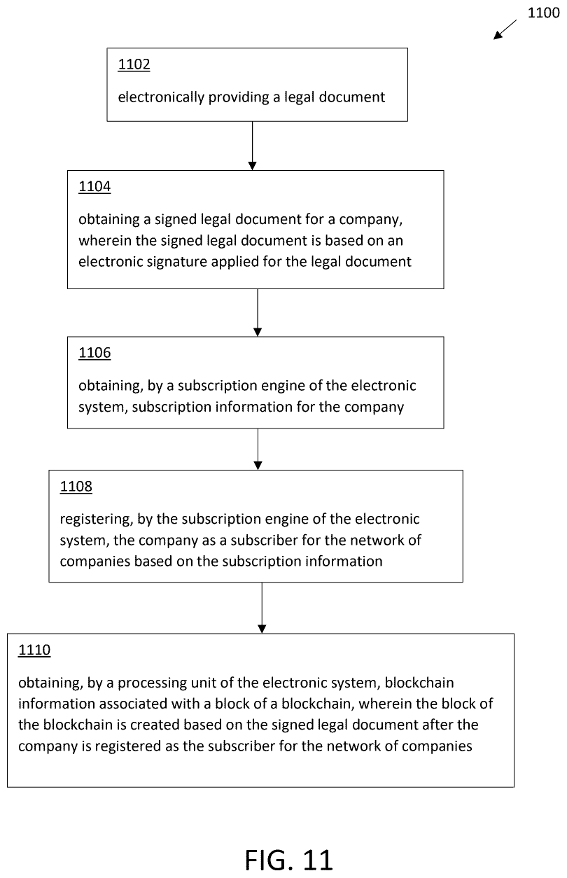

FIG. 11 illustrates an example of a method 1100 that may be performed by the electronic system 400. The method 1100 may be performed by the electronic system 400 for creating and maintaining a network of companies having legal obligations with each other. The method 1100 includes: electronically providing a legal document (item 1102); obtaining a signed legal document for a company, wherein the signed legal document is based on an electronic signature applied for the legal document (item 1104); obtaining, by a subscription engine of the electronic system, subscription information for the company (item 1106); registering, by the subscription engine of the electronic system, the company as a subscriber for the network of companies based on the subscription information (item 1108); and obtaining, by a processing unit of the electronic system, blockchain information associated with a block of a blockchain, wherein the block of the blockchain is created based on the signed legal document after the company is registered as the subscriber for the network of companies (item 1110).

Optionally, in the method 1100, the processing unit is configured to interface with a blockchain engine configured to create the block of the blockchain, and to link the created block together with other blocks of the blockchain via cryptography.

Optionally, in the method 1100, another block of the blockchain is associated with another company in the network of companies.

Optionally, in the method 1100, the other block of the blockchain is associated with an event in which the other company joins the network of companies.

Optionally, in the method 1100, the other block of the blockchain is associated with an event in which the other company leaves the network of companies.

Optionally, in the method 1100, the legal document comprises a non-disclosure agreement.

Optionally, in the method 1100, the legal document is an agreement between the company and a provider or an owner of the electronic system.

Optionally, in the method 1100, one or more of companies in the network of companies are third-party beneficiaries under the agreement.

Optionally, in the method 1100, the processing unit is configured to communicate with a blockchain-service provider.

Optionally, in the method 1100, the blockchain-service provider is Amazon Quantum Ledger Database (QLDB).

Optionally, the method 100 further includes: extracting, by an extractor of the electronic system, information from the signed legal document; providing the extracted information to the blockchain-service provider, and obtaining the blockchain information, wherein the block of the blockchain is provided by the blockchain-service provider based on the extracted information.

Optionally, in the method 1100, the signed legal document is obtained via a communication interface of the electronic system, the communication interface configured to interface with a document-service provider.

Optionally, in the method 1100, the document-service provider is DocuSign.

Optionally, in the method 1100, the communication interface is a part of an electronic legal document provider of the electronic system.

Optionally, the method 1100 further includes storing company information of the company in a non-transitory medium of the electronic system.

Optionally, the method 1100 further includes storing the blockchain information in a non-transitory medium of the electronic system.

Optionally, in the method 1100, the blockchain information is stored in the non-transitory medium in association with company information of the company.

Optionally, the method 1100 further comprises obtaining company information of the company, wherein the company information comprises one or more of: a name of the company, an address of the company, a jurisdiction of the company, or contact information of the company.

Optionally, in the method 1100, the blockchain information comprises one or more of: a block address, a digest, a digest tip address, or hash information.

Optionally, in the method 1100, the legal document is electronically generated based on company information of the company.

Optionally, in the method 1100, the blockchain is configured to implement, and/or to support, a fabric of confidentiality that comprises confidentiality obligations among companies in the network of companies.

Optionally, in the method 1100, the signed legal document is secured in a blockchain ledger of the blockchain.

Optionally, the method 1100 further includes providing a user-interface, by a user-interface generator of the electronic system.

Optionally, in the method 1100, the user-interface is configured to allow a user to enter company information of the company, and to provide the electronic signature for the legal document.

Optionally, in the method 1100, the user-interface is also configured to allow a user to provide the subscription information for the company.

Optionally, in the method 1100, the user-interface is configured to allow a user to view a list of companies in the network of companies.

Optionally, in the method 1100, the user-interface is configured to allow a user to un-subscribe the company for the network of companies.

Optionally, in the method 1100, the user-interface is configured to allow a user to enter document information regarding another signed legal document for authentication of the other signed legal document.

### Legal Fabric Management System

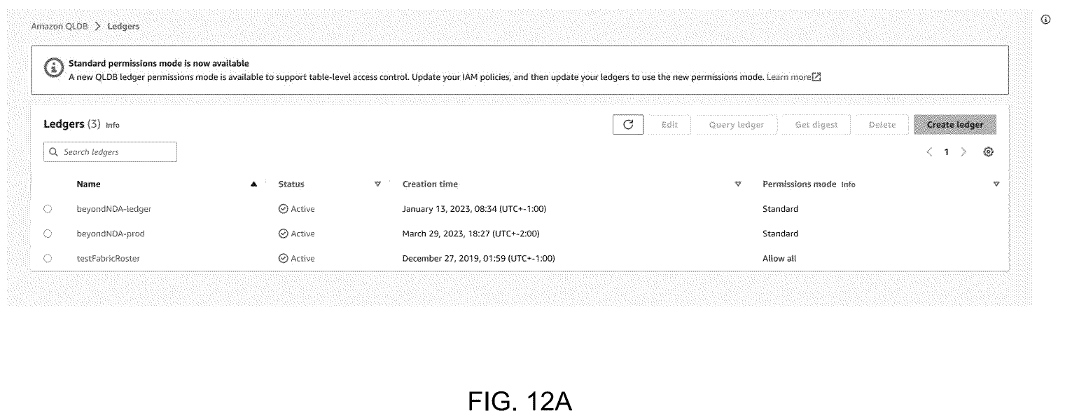

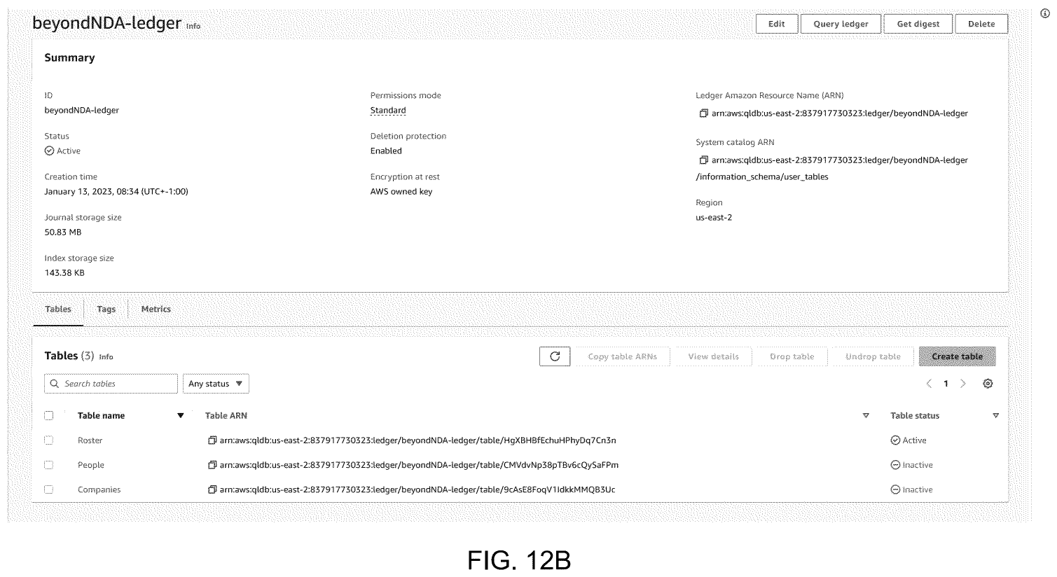

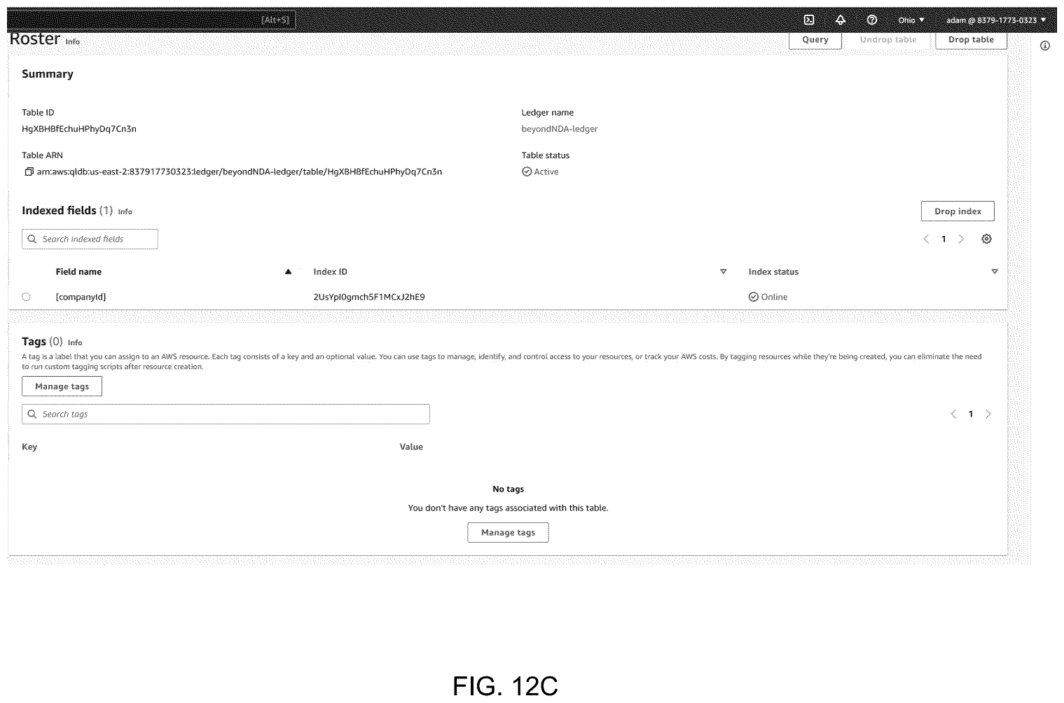

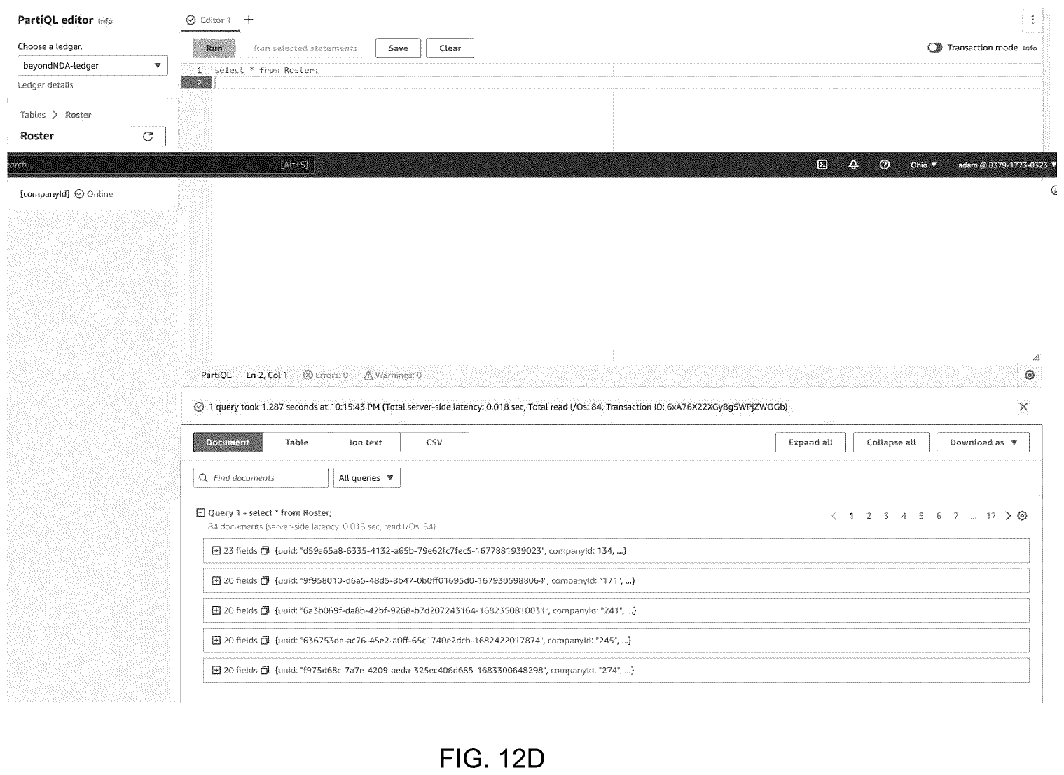

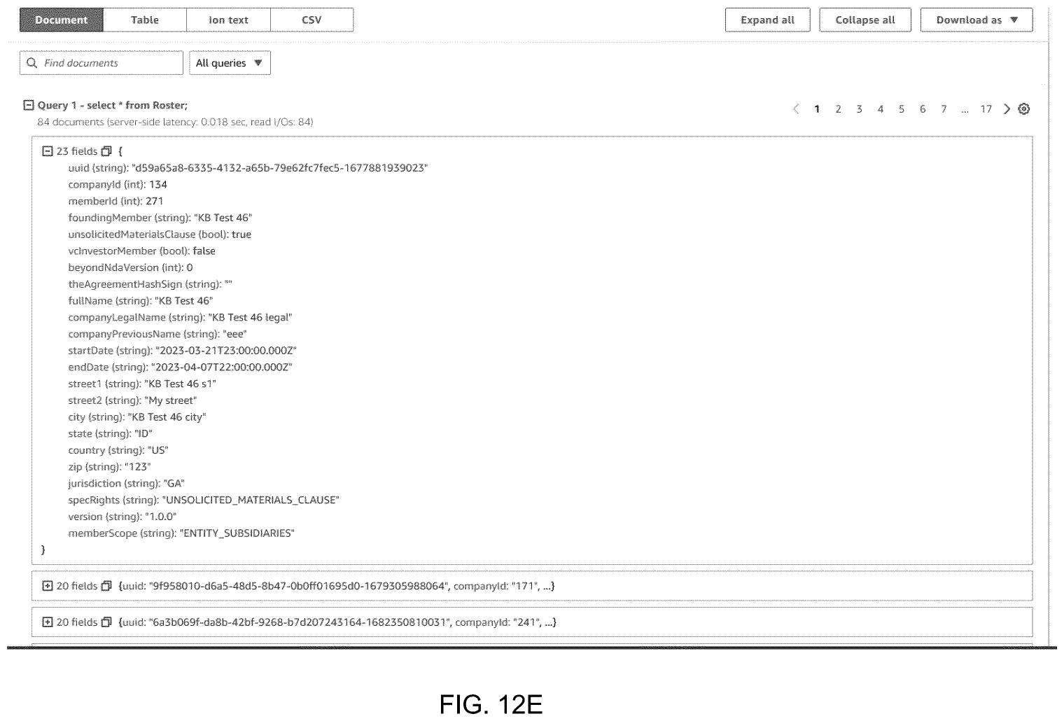

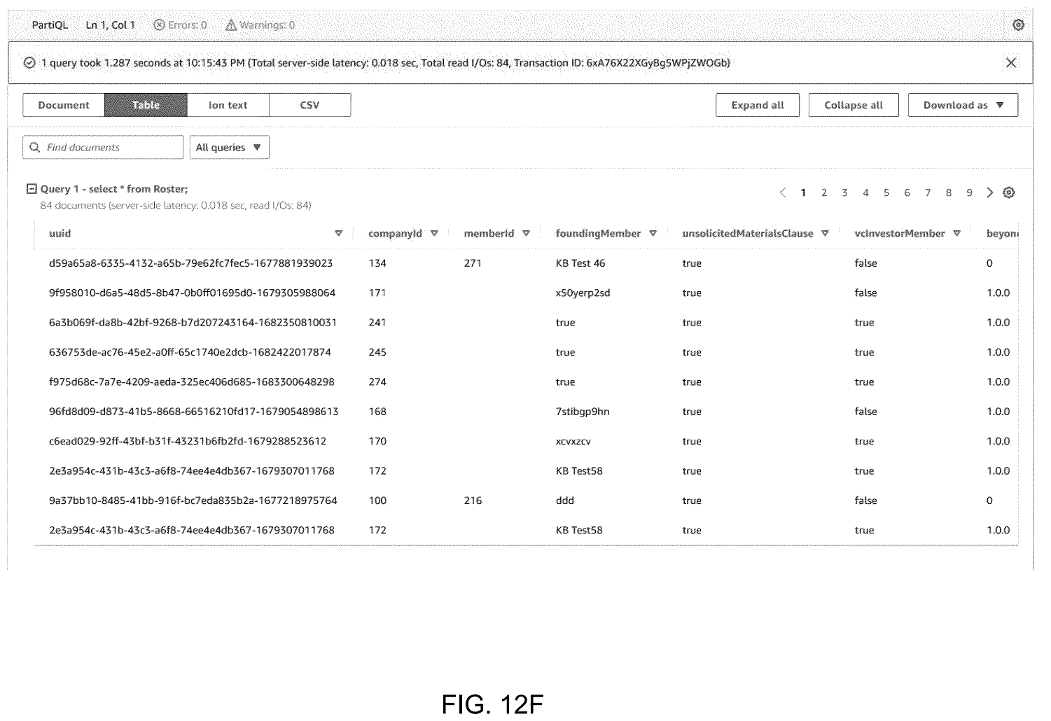

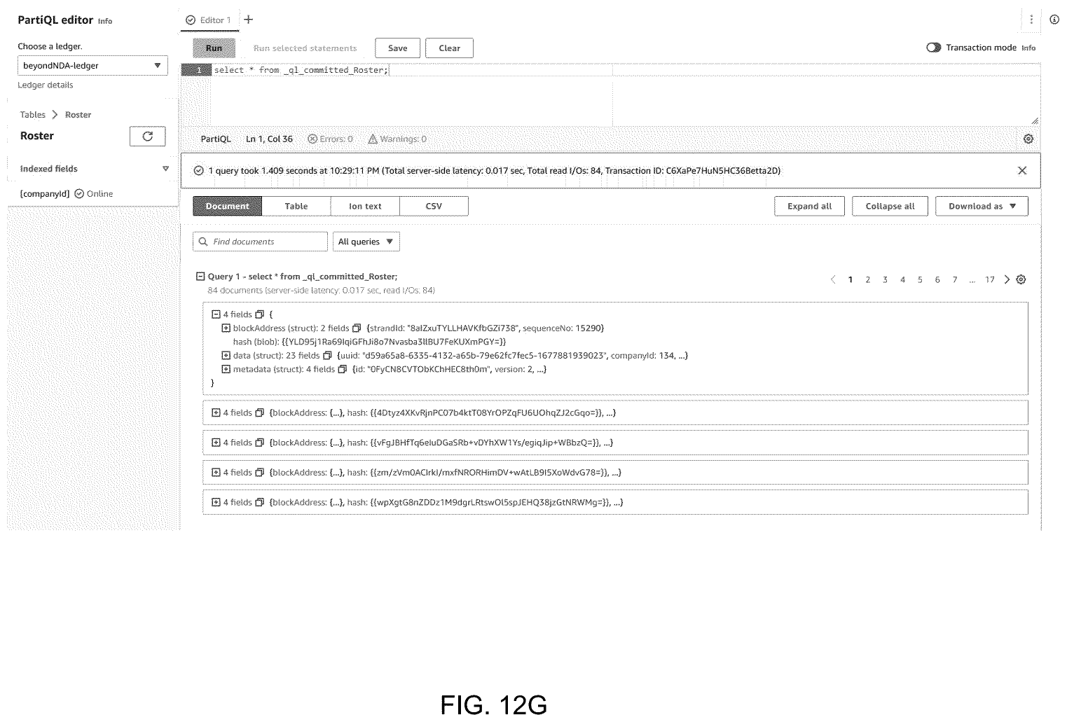

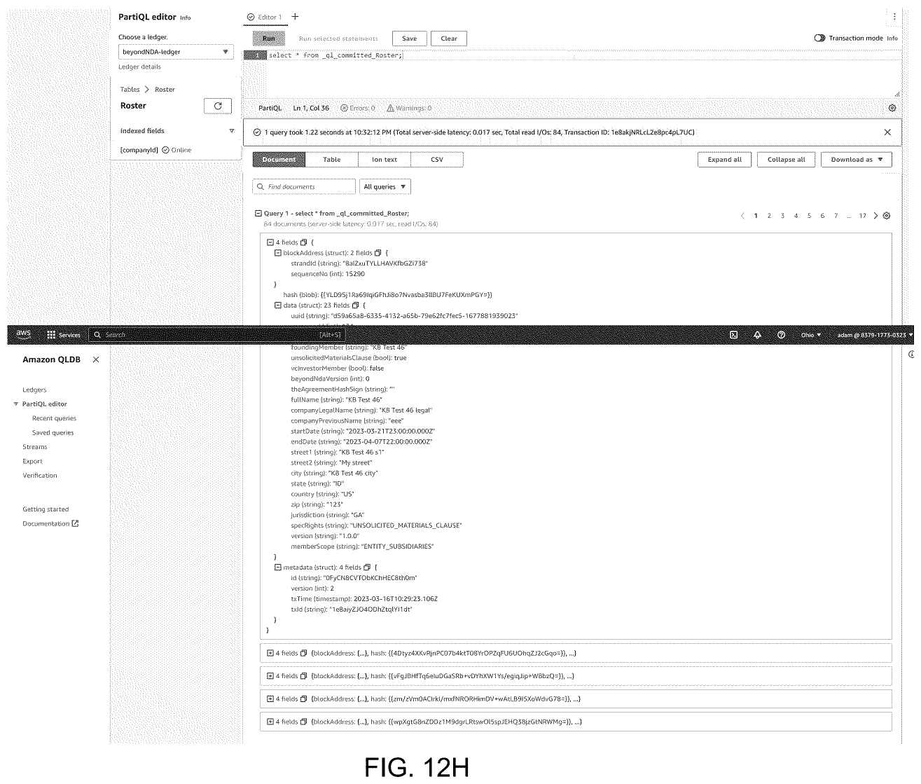

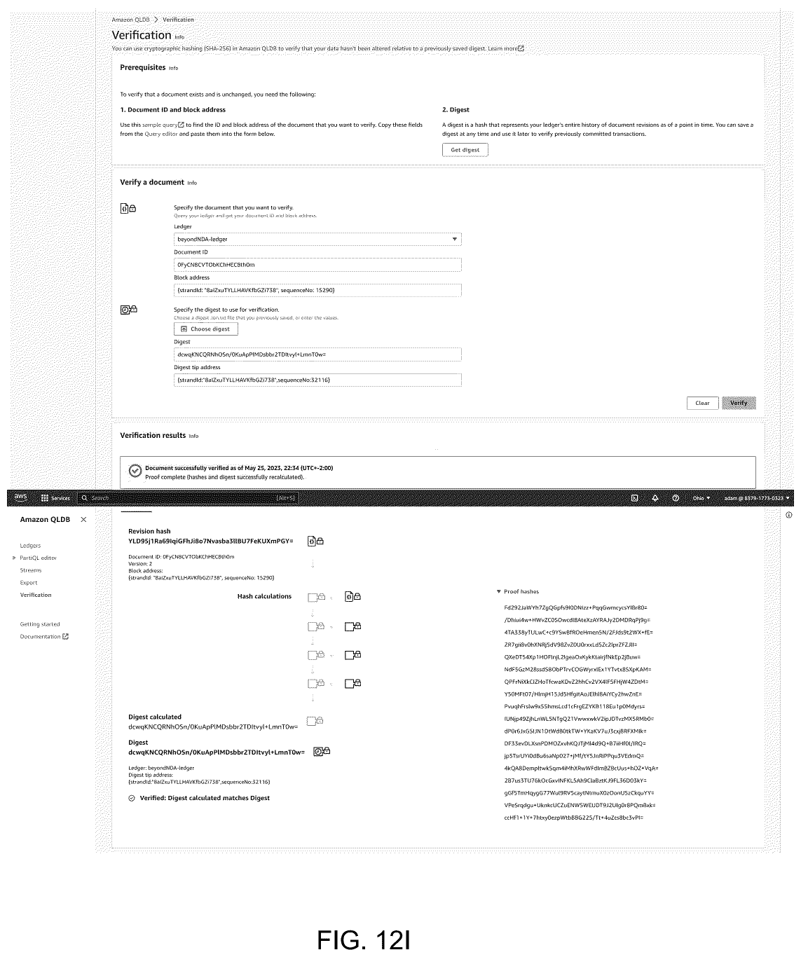

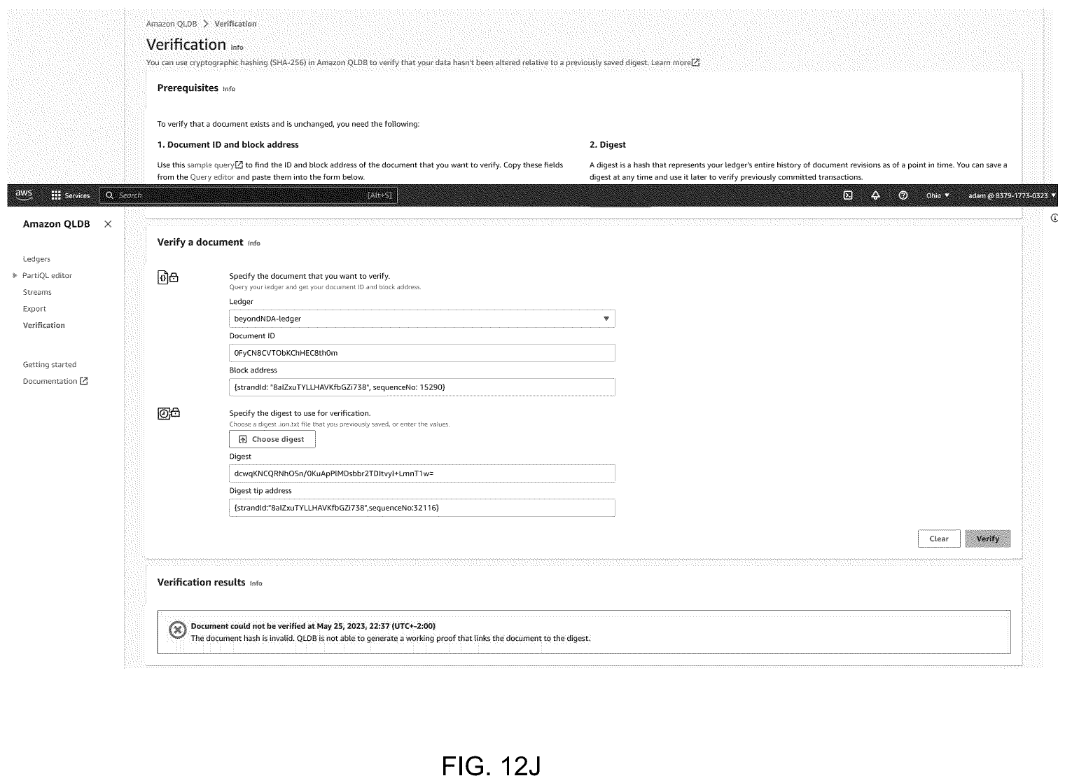

In some cases, the electronic system 400 may provide a management function that allows the legal fabric for the network of companies to be managed. As discussed, the electronic system 400 may be configured to provide certain formation regarding the companies that are subscribed in the network of companies. FIGS. 12A-12J illustrates examples of information that may be provided by the electronic system 400. As shown in FIG. 12A, the electronic system 400 may be configured to provide a list (a ledger) of companies that are in the network. The list may also indicate the respective statuses of the companies (e.g., whether the company is active or not active), and/or the respective subscription/membership creation times. In some cases, the information shown in FIG. 12A may be provided to an administrator of the provider of the electronic system 400. In one implementation, the information shown may be provided by the blockchain-service provider 450 for production, testing, and/or staging. The electronic system 400 receives such information and provides such information in a user interface. Alternatively or additionally, the information shown in FIG. 12A may be provided to a user associated with a company via the user interface (e.g., a website) provided by the user-interface generator 440, in response to the user's request to retrieve such information.

FIG. 12B illustrates an overview of a ledger, which includes information about registered companies and associated users (“people”). The information also includes a roster table that keeps track of all signed agreements. In some cases, the information shown in FIG. 12B may be provided to an administrator of the provider of the electronic system 400. In one implementation, the information shown may be provided by the blockchain-service provider 450 to the electronic system 400, which then provides the information in a user interface. Alternatively or additionally, the information shown in FIG. 12B may be provided to a user associated with a company via the user interface (e.g., a website) provided by the user-interface generator 440, in response to the user's request to retrieve such information.

FIG. 12C illustrates an example of an overview of a roster that may be provided by the electronic system 400. The overview contains information regarding the roster. The information may include a link for accessing the roster, an identifier of a roster, an address of the roster, a status of the roster, a last update time for the roster, or any combination of the foregoing. In some cases, the information shown in FIG. 12C may be provided to an administrator of the provider of the electronic system 400. In one implementation, the information shown may be provided by the blockchain-service provider 450 to the electronic system 400, which then provides the information in a user interface. Alternatively or additionally, the information shown in FIG. 12C may be provided to a user associated with a company via the user interface (e.g., a website) provided by the user-interface generator 440, in response to the user's request to retrieve such information.

FIG. 12D illustrates details of a roster. In some cases, the information shown may be provided in response to the roster of FIG. 12C being selected. As shown in FIG. 12D, the details of the roster includes a list of companies (those in the network of companies) and the number of fields for the respective companies. The roster may also include respective storage addresses/links for accessing details of the respective companies. In some cases, the information shown in FIG. 12D may be provided to an administrator of the provider of the electronic system 400. In one implementation, the information shown may be provided by the blockchain-service provider 450 to the electronic system 400, which then provides the information in a user interface. Alternatively or additionally, the information shown in FIG. 12D may be provided to a user associated with a company via the user interface (e.g., a website) provided by the user-interface generator 440, in response to the user's request to retrieve such information.

FIG. 12E illustrates an example of a list of fields for a company selected from the roster of FIG. 12D. In the illustrated example, the selected company from the roster has 23 fields. Some of the fields are: company identifier, member identifier, name of founding member, company name, previous name of the company, start date (date that the company joined the network), end date (date that the company left the network), street name for the company, city in which the company is located, state in which the company is located, zip code for the company, country in which the company is located, jurisdiction for the company, version identifier for the agreement signed by the company, and scope of membership for the company, identifier indicating whether company selected “unsolicited materials clause” or not, and identifier indicating whether company has venture capital (VC)/investor rights or not. In some cases, the information shown in FIG. 12E may be provided to an administrator of the provider of the electronic system 400. In one implementation, the information shown may be provided by the blockchain-service provider 450 to the electronic system 400, which then provides the information in a user interface. Alternatively or additionally, the information shown in FIG. 12E may be provided to a user associated with a company via the user interface (e.g., a website) provided by the user-interface generator 440, in response to the user's request to retrieve such information.

FIG. 12F illustrates an example of an alternative view of the roster of FIG. 12D that may be provided by the electronic system 400. The alternative view of the roster is in a form of a table that lists company identifiers of the respective companies in the network, respective member identifiers for the respective companies, respective indicators indicating whether the companies select “unsolicited materials clause” or not. Generally, any of the fields shown in FIG. 12E may be presented in a column in the table of FIG. 12F. In some cases, the information shown in FIG. 12F may be provided to an administrator of the provider of the electronic system 400. In one implementation, the information shown may be provided by the blockchain-service provider 450 to the electronic system 400, which then provides the information in a user interface. Alternatively or additionally, the information shown in FIG. 12F may be provided to a user associated with a company via the user interface (e.g., a website) provided by the user-interface generator 440, in response to the user's request to retrieve such information.

FIG. 12G illustrates information that are specific to the blockchain and its cryptography for the network of companies. The information is provided in a table, wherein each entry in the table is for a respective company. As shown in the example, when an entry is selected for the corresponding company, the entry is expanded to provide additional information for the company, such as, block address for the block of the blockchain that is specific for the company, hash information for the company, data for the company, and metadata for the company. In some cases, the information shown in FIG. 12G may be provided to an administrator of the provider of the electronic system 400. In one implementation, the information shown may be provided by the blockchain-service provider 450 to the electronic system 400, which then provides the information in a user interface. Alternatively or additionally, the information shown in FIG. 12G may be provided to a user associated with a company via the user interface (e.g., a website) provided by the user-interface generator 440, in response to the user's request to retrieve such information.

FIG. 12H illustrates an expanded view of one of the entries in the table of FIG. 12G. In some cases, the information shown in FIG. 12H may be provided to an administrator of the provider of the electronic system 400. In one implementation, the information shown may be provided by the blockchain-service provider 450 to the electronic system 400, which then provides the information in a user interface. Alternatively or additionally, the information shown in FIG. 12H may be provided to a user associated with a company via the user interface (e.g., a website) provided by the user-interface generator 440, in response to the user's request to retrieve such information.

In some cases, a user (e.g., administrator of the electronic system 400, or a user associated with a company) of the electronic system 400 may provide a document identifier and a block address for verification by the electronic system 400. FIG. 12I illustrates an example in which a user has provided a document identifier and a block address for verification. The user may also input a digest and/or digest tip address. Based on these information, the blockchain-service provider 450 then calculates a digest to obtain a calculated digest. If the calculated digest matches the input digest, then the verification is considered successful. On the other hand, if the calculated digest does not match the input digest, then the verification is considered unsuccessful (FIG. 12J). In some cases, the information shown in FIGS. 12I-12J may be provided to an administrator of the provider of the electronic system 400. In one implementation, the information shown may be provided by the blockchain-service provider 450 to the electronic system 400, which then provides the information in a user interface. Alternatively or additionally, the information shown in FIGS. 12I-12J may be provided to a user associated with a company via the user interface (e.g., a website) provided by the user-interface generator 440, in response to the user's request to retrieve such information.

### Specialized Processing System

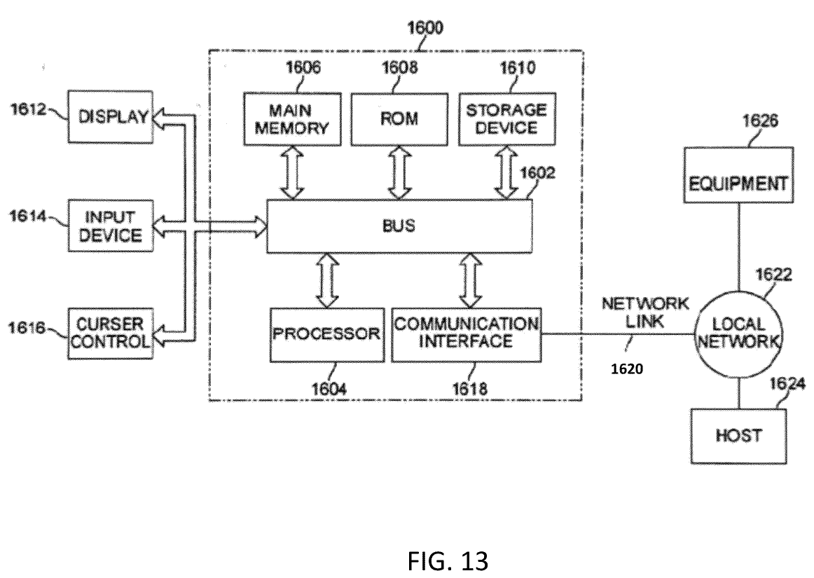

FIG. 13 illustrates a specialized processing system 1600 for implementing one or more features described herein. For examples, the processing system 1600 may implement the electronic system 400, or at least a part of the electronic system 400, such as the processing unit 430 of the electronic system 400. In some embodiments, the processing system 1600 may be configured to perform the method 1100 described herein.

Processing system 1600 includes a bus 1602 or other communication mechanism for communicating information, and a processor 1604 coupled with the bus 1602 for processing information. The processor system 1600 also includes a main memory 1606, such as a random access memory (RAM) or other dynamic storage device, coupled to the bus 1602 for storing information and instructions to be executed by the processor 1604. The main memory 1606 also may be used for storing temporary variables or other intermediate information during execution of instructions to be executed by the processor 1604. The processor system 1600 further includes a read only memory (ROM) 1608 or other static storage device coupled to the bus 1602 for storing static information and instructions for the processor 1604. A data storage device 1610, such as a magnetic disk or optical disk, is provided and coupled to the bus 1602 for storing information and instructions.

The processor system 1600 may be coupled via the bus 1602 to a display 1612, such as a screen or a flat panel, for displaying information to a user. An input device 1614, including alphanumeric and other keys, or a touchscreen, and/or any of other data capture devices (sensors), is coupled to the bus 1602 for communicating information and command selections to processor 1604. Another type of user input device is cursor control 1616, such as a 2D touchpad, a touchscreen, a trackball, or cursor direction keys for communicating direction information and command selections to processor 1604 and/or for controlling cursor movement on display 1612. This input device typically has two degrees of freedom in two axes, a first axis (e.g., x) and a second axis (e.g., y), that allows the device to specify positions in a plane. The input device 1614 and/or the cursor control device 1616 may be the same device in some embodiments. Also, the input device 1614 and/or the cursor control device 1616 may be any 2D input device or 3D input device.

In some embodiments, the processor system 1600 can be used to perform various functions described herein. According to some embodiments, such use is provided by processor system 1600 in response to processor 1604 executing one or more sequences of one or more instructions contained in the main memory 1606. Those skilled in the art will know how to prepare such instructions based on the functions and methods described herein. Such instructions may be read into the main memory 1606 from another processor-readable medium, such as storage device 1610. Execution of the sequences of instructions contained in the main memory 1606 causes the processor 1604 to perform the process steps described herein. One or more processors in a multi-processing arrangement may also be employed to execute the sequences of instructions contained in the main memory 1606. In alternative embodiments, hard-wired circuitry may be used in place of or in combination with software instructions to implement the various embodiments described herein. Thus, embodiments are not limited to any specific combination of hardware circuitry and software.

The term “processor-readable medium” as used herein refers to any medium that participates in providing instructions to the processor 1604 for execution. Such a medium may take many forms, including but not limited to, non-volatile media, volatile media, and transmission media. Non-volatile media includes, for example, optical or magnetic disks, SD disks, such as the storage device 1610. A non-volatile medium may be considered an example of non-transitory medium. Volatile media includes dynamic memory, such as the main memory 1606. A volatile medium may be considered an example of non-transitory medium. Transmission media includes cables, wire and fiber optics, including the wires that comprise the bus 1602. Transmission media can also take the form of acoustic or light waves, such as those generated during radio wave and infrared data communications.

Common forms of processor-readable media include, for example, hard disk, a magnetic medium, a CD-ROM, any other optical medium, a RAM, a PROM, and EPROM, a FLASH-EPROM, any other memory chip or cartridge, a carrier wave as described hereinafter, or any other medium from which a processor can read.

Various forms of processor-readable media may be involved in carrying one or more sequences of one or more instructions to the processor 1604 for execution. For example, the instructions may initially be carried on a storage of a remote computer or remote device. The remote computer or device can send the instructions over a network, such as the Internet. A receiving unit local to the processing system 1600 can receive the data from the network, and provide the data on the bus 1602. The bus 1602 carries the data to the main memory 1606, from which the processor 1604 retrieves and executes the instructions. The instructions received by the main memory 1606 may optionally be stored on the storage device 1610 either before or after execution by the processor 1604.

The processing system 1600 also includes a communication interface 1618 coupled to the bus 1602. The communication interface 1618 provides a two-way data communication coupling to a network link 1620 that is connected to a local network 1622. For example, the communication interface 1618 may be an integrated services digital network (ISDN) card to provide a data communication. As another example, the communication interface 1618 may be a local area network (LAN) card to provide a data communication connection to a compatible LAN. Wireless links may also be implemented. In any such implementation, the communication interface 1618 sends and receives electrical, electromagnetic or optical signals that carry data streams representing various types of information.

The network link 1620 typically provides data communication through one or more networks to other devices. For example, the network link 1620 may provide a connection through local network 1622 to a host computer 1624 or to equipment 1626. The data streams transported over the network link 1620 can comprise electrical, electromagnetic or optical signals. The signals through the various networks and the signals on the network link 1620 and through the communication interface 1618, which carry data to and from the processing system 1600, are exemplary forms of carrier waves transporting the information. The processing system 1600 can send messages and receive data, including program code, through the network(s), the network link 1620, and the communication interface 1618.

As used in this specification, the term “product” may refer to any human-made and/or machine-made article/item. By means of non-limiting examples, the product may be an electronic device, a hardware and/or software component of an electronic device, an application in a cloud/server, etc.

Also, as used in this specification, the term “processing unit” may refer to one or more hardware processors, one or more software or application modules, or a combination of hardware and software. By means of non-limiting examples, a processing unit may be one or more signal processors, one or more general purpose processors, one or more ASIC processors, one or more FPGA processors, one or more applications, or any combination of the foregoing.

One or more embodiments described herein include one or more features in accordance with one or more of the following items:

Item 1. An electronic system for creating and maintaining a network of companies having legal obligations with each other, the electronic system comprising:
an electronic legal document provider configured to

electronically provide a legal document; and

obtain a signed legal document for the company, wherein the signed legal document is based on an electronic signature applied for the legal document;
a subscription engine configured to obtain subscription information for a company, and register the company as a subscriber for the network of companies based on the subscription information; and
a processing unit configured to obtain blockchain information associated with a block of a blockchain, wherein the block of the blockchain is created based on the signed legal document after the company is registered as the subscriber for the network of companies.
   Item 2. The electronic system of item 1, wherein the processing unit is configured to interface with a blockchain engine configured to create the block of the blockchain, and to link the created block together with other blocks of the blockchain via cryptography.
   Item 3. The electronic system of item 1, wherein another block of the blockchain is associated with another company in the network of companies.
   Item 4. The electronic system of item 3, wherein the other block of the blockchain is associated with an event in which the other company joins the network of companies.
   Item 5. The electronic system of item 3, wherein the other block of the blockchain is associated with an event in which the other company leaves the network of companies.
   Item 6. The electronic system of item 1, wherein the legal document comprises a non-disclosure agreement.
   Item 7. The electronic system of item 1, wherein the legal document is an agreement between the company and a provider or an owner of the electronic system.
   Item 8. The electronic system of item 7, wherein one or more of companies in the network of companies are third-party beneficiaries under the agreement.
   Item 9. The electronic system of item 1, wherein the processing unit is configured to communicate with a blockchain-service provider.
   Item 10. The electronic system of item 9, wherein the blockchain-service provider is Amazon Quantum Ledger Database (QLDB).
   Item 11. The electronic system of item 9, further comprising an extractor configured to extract information from the signed legal document, provide the extracted information to the blockchain-service provider, and obtain the blockchain information, wherein the block of the blockchain is provided by the blockchain-service provider based on the extracted information.
   Item 12. The electronic system of item 1, wherein the electronic legal document provider is configured to interface with a document-service provider.
   Item 13. The electronic system of item 12, wherein the document-service provider is DocuSign.
   Item 14. The electronic system of item 12, wherein the electronic legal document provider is configured to obtain the signed legal document from the document-service provider.
   Item 15. The electronic system of item 1, further comprising a non-transitory medium storing company information of the company.
   Item 16. The electronic system of item 1, further comprising a non-transitory medium storing the blockchain information.
   Item 17. The electronic system of item 16, wherein the non-transitory medium is configured to store the blockchain information in association with company information of the company.
   Item 18. The electronic system of item 1, wherein the electronic system is configured to obtain company information of the company, and wherein the company information comprises one or more of: a name of the company, an address of the company, a jurisdiction of the company, or contact information of the company.
   Item 19. The electronic system of item 1, wherein the blockchain information comprises one or more of: a block address, a digest, a digest tip address, or hash information.
   Item 20. The electronic system of item 1, wherein the electronic legal document provider is configured to electronically generate the legal document based on company information of the company.
   Item 21. The electronic system of item 1, wherein the blockchain is configured to implement, and/or to support, a fabric of confidentiality that comprises confidentiality obligations among companies in the network of companies.
   Item 22. The electronic system of item 1, wherein the signed legal document is secured in a blockchain ledger of the blockchain.
   Item 23. The electronic system of item 1, further comprising a user-interface generator configured to provide a user-interface.
   Item 24. The electronic system of item 23, wherein the user-interface is configured to allow a user to enter company information of the company, and to provide the electronic signature for the legal document.
   Item 25. The electronic system of item 23, wherein the user-interface is also configured to allow a user to provide the subscription information for the company.
   Item 26. The electronic system of item 23, wherein the user-interface is configured to allow a user to view a list of companies in the network of companies.
   Item 27. The electronic system of item 23, wherein the user-interface is configured to allow a user to un-subscribe the company for the network of companies.
   Item 28. The electronic system of item 23, wherein the user-interface is configured to allow a user to enter document information regarding another signed legal document for authentication of the other signed legal document.
   Item 29. A method performed by an electronic system configured for creating and maintaining a network of companies having legal obligations with each other, the method comprising:
electronically providing a legal document;
obtaining a signed legal document for the company, wherein the signed legal document is based on an electronic signature applied for the legal document;
obtaining, by a subscription engine of the electronic system, subscription information for a company;
registering, by the subscription engine of the electronic system, the company as a subscriber for the network of companies based on the subscription information; and
obtaining, by a processing unit of the electronic system, blockchain information associated with a block of a blockchain, wherein the block of the blockchain is created based on the signed legal document after the company is registered as the subscriber for the network of companies.
   Item 30. The method of item 29, wherein the processing unit is configured to interface with a blockchain engine configured to create the block of the blockchain, and to link the created block together with other blocks of the blockchain via cryptography.
   Item 31. The method of item 29, wherein another block of the blockchain is associated with another company in the network of companies.
   Item 32. The method of item 31, wherein the other block of the blockchain is associated with an event in which the other company joins the network of companies.
   Item 33. The method of item 31, wherein the other block of the blockchain is associated with an event in which the other company leaves the network of companies.
   Item 34. The method of item 29, wherein the legal document comprises a non-disclosure agreement.
   Item 35. The method of item 29, wherein the legal document is an agreement between the company and a provider or an owner of the electronic system.
   Item 36. The method of item 35, wherein one or more of companies in the network of companies are third-party beneficiaries under the agreement.
   Item 37. The method of item 29, wherein the processing unit is configured to communicate with a blockchain-service provider.
   Item 38. The method of item 37, wherein the blockchain-service provider is Amazon Quantum Ledger Database (QLDB).
   Item 39. The method of item 37, further comprising:
extracting, by an extractor of the electronic system, information from the signed legal document;
providing the extracted information to the blockchain-service provider, and
obtaining the blockchain information, wherein the block of the blockchain is provided by the blockchain-service provider based on the extracted information.
   Item 40. The method of item 29, wherein the signed legal document is obtained via a communication interface of the electronic system, the communication interface configured to interface with a document-service provider.
   Item 41. The method of item 40, wherein the document-service provider is DocuSign.
   Item 42. The method of item 40, wherein the communication interface is a part of an electronic legal document provider of the electronic system.
   Item 43. The method of item 29, further comprising storing company information of the company in a non-transitory medium of the electronic system.
   Item 44. The method of item 29, further comprising storing the blockchain information in a non-transitory medium of the electronic system.
   Item 45. The method of item 44, wherein the blockchain information is stored in the non-transitory medium in association with company information of the company.
   Item 46. The method of item 29, wherein the method comprises obtaining company information of the company, and wherein the company information comprises one or more of: a name of the company, an address of the company, a jurisdiction of the company, or contact information of the company.
   Item 47. The method of item 29, wherein the blockchain information comprises one or more of: a block address, a digest, a digest tip address, or hash information.
   Item 48. The method of item 29, wherein the legal document is electronically generated based on company information of the company.
   Item 49. The method of item 29, wherein the blockchain is configured to implement, and/or to support, a fabric of confidentiality that comprises confidentiality obligations among companies in the network of companies.
   Item 50. The method of item 29, wherein the signed legal document is secured in a blockchain ledger of the blockchain.
   Item 51. The method of item 29, further comprising providing a user-interface, by a user-interface generator of the electronic system.
   Item 52. The method of item 51, wherein the user-interface is configured to allow a user to enter company information of the company, and to provide the electronic signature for the legal document.
   Item 53. The method of item 51, wherein the user-interface is also configured to allow a user to provide the subscription information for the company.
   Item 54. The method of item 51, wherein the user-interface is configured to allow a user to view a list of companies in the network of companies.
   Item 55. The method of item 51, wherein the user-interface is configured to allow a user to un-subscribe the company for the network of companies.
   Item 56. The method of item 51, wherein the user-interface is configured to allow a user to enter document information regarding another signed legal document for authentication of the other signed legal document.
   Item 57. A product having one or more non-transitory media storing a set of instructions, wherein an execution of the instructions will cause a method to be performed by an electronic system configured for creating and maintaining a network of companies having legal obligations with each other, the method comprising:
electronically providing a legal document;
obtaining a signed legal document for a company, wherein the signed legal document is based on an electronic signature applied for the legal document;
obtaining, by a subscription engine of the electronic system, subscription information for the company;
registering, by the subscription engine of the electronic system, the company as a subscriber for the network of companies based on the subscription information; and
obtaining, by a processing unit of the electronic system, blockchain information associated with a block of a blockchain, wherein the block of the blockchain is created based on the signed legal document after the company is registered as the subscriber for the network of companies.
   Item 58. The product of item 57, wherein the processing unit is configured to interface with a blockchain engine configured to create the block of the blockchain, and to link the created block together with other blocks of the blockchain via cryptography.
   Item 59. The product of item 57, wherein another block of the blockchain is associated with another company in the network of companies.
   Item 60. The product of item 59, wherein the other block of the blockchain is associated with an event in which the other company joins the network of companies.
   Item 61. The product of item 59, wherein the other block of the blockchain is associated with an event in which the other company leaves the network of companies.
   Item 62. The product of item 57, wherein the legal document comprises a non-disclosure agreement.
   Item 63. The product of item 57, wherein the legal document is an agreement between the company and a provider or an owner of the electronic system.
   Item 64. The product of item 63, wherein one or more of companies in the network of companies are third-party beneficiaries under the agreement.
   Item 65. The product of item 57, wherein the processing unit is configured to communicate with a blockchain-service provider.
   Item 66. The product of item 65, wherein the blockchain-service provider is Amazon Quantum Ledger Database (QLDB).
   Item 67. The product of item 65, wherein the method further comprises:
extracting, by an extractor of the electronic system, information from the signed legal document;
providing the extracted information to the blockchain-service provider, and
obtaining the blockchain information, wherein the block of the blockchain is provided by the blockchain-service provider based on the extracted information.
   Item 68. The product of item 57, wherein the signed legal document is obtained via a communication interface of the electronic system, the communication interface configured to interface with a document-service provider.
   Item 69. The product of item 68, wherein the document-service provider is DocuSign.
   Item 70. The product of item 68, wherein the communication interface is a part of an electronic legal document provider of the electronic system.
   Item 71. The product of item 57, wherein the method further comprises storing company information of the company in a non-transitory medium of the electronic system.
   Item 72. The product of item 57, wherein the method further comprises storing the blockchain information in a non-transitory medium of the electronic system.
   Item 73. The product of item 72, wherein the blockchain information is stored in the non-transitory medium in association with company information of the company.
   Item 74. The product of item 57, wherein the method comprises obtaining company information of the company, and wherein the company information comprises one or more of: a name of the company, an address of the company, a jurisdiction of the company, or contact information of the company.
   Item 75. The product of item 57, wherein the blockchain information comprises one or more of: a block address, a digest, a digest tip address, or hash information.
   Item 76. The product of item 57, wherein the legal document is electronically generated based on company information of the company.
   Item 77. The product of item 57, wherein the blockchain is configured to implement, and/or to support, a fabric of confidentiality that comprises confidentiality obligations among companies in the network of companies.
   Item 78. The product of item 57, wherein the signed legal document is secured in a blockchain ledger of the blockchain.
   Item 79. The product of item 57, wherein the method further comprises providing a user-interface, by a user-interface generator of the electronic system.
   Item 80. The product of item 79, wherein the user-interface is configured to allow a user to enter company information of the company, and to provide the electronic signature for the legal document.
   Item 81. The product of item 79, wherein the user-interface is also configured to allow a user to provide the subscription information for the company.
   Item 82. The product of item 79, wherein the user-interface is configured to allow a user to view a list of companies in the network of companies.
   Item 83. The product of item 79, wherein the user-interface is configured to allow a user to un-subscribe the company for the network of companies.
   Item 84. The product of item 79, wherein the user-interface is configured to allow a user to enter document information regarding another signed legal document for authentication of the other signed legal document.

Although particular features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications and equivalents.

1. An electronic system for creating and maintaining a network of companies having legal obligations with each other, the electronic system comprising:
an electronic legal document provider configured to
electronically provide a legal document; and
obtain a signed legal document for a company, wherein the signed legal document is based on an electronic signature applied for the legal document;
a subscription engine configured to obtain subscription information for the company, and register the company as a subscriber for the network of companies based on the subscription information; and
a processing unit configured to obtain blockchain information associated with a block of a blockchain, wherein the block of the blockchain is created based on the signed legal document after the company is registered as the subscriber for the network of companies.

2. The electronic system of claim 1, wherein the processing unit is configured to interface with a blockchain engine configured to create the block of the blockchain, and to link the created block together with other blocks of the blockchain via cryptography.

3. The electronic system of claim 1, wherein another block of the blockchain is associated with another company in the network of companies.

4. The electronic system of claim 3, wherein the other block of the blockchain is associated with an event in which the other company joins the network of companies.

5. The electronic system of claim 3, wherein the other block of the blockchain is associated with an event in which the other company leaves the network of companies.

6. The electronic system of claim 1, wherein the legal document comprises a non-disclosure agreement.

7. The electronic system of claim 1, wherein the legal document is an agreement between the company and a provider or an owner of the electronic system, and/or wherein one or more of companies in the network of companies are third-party beneficiaries under the agreement.

8. (canceled)

9. The electronic system of claim 1, wherein the processing unit is configured to communicate with a blockchain-service provider.

10. The electronic system of claim 9, wherein the blockchain-service provider is Amazon Quantum Ledger Database (QLDB).

11. The electronic system of claim 9, further comprising an extractor configured to extract information from the signed legal document, provide the extracted information to the blockchain-service provider, and obtain the blockchain information, wherein the block of the blockchain is provided by the blockchain-service provider based on the extracted information.

12. The electronic system of claim 1, wherein the electronic legal document provider is configured to interface with a document-service provider, and wherein the electronic legal document provider is configured to obtain the signed legal document from the document-service provider.

13-16. (canceled)

17. The electronic system of claim 16, further comprising a non-transitory medium is configured to store the blockchain information in association with company information of the company.

18. The electronic system of claim 1, wherein the electronic system is configured to obtain company information for the company, and wherein the company information comprises one or more of: a name of the company, an address of the company, a jurisdiction of the company, or contact information of the company.

19. The electronic system of claim 1, wherein the blockchain information comprises one or more of: a block address, a digest, a digest tip address, or hash information.

20. The electronic system of claim 1, wherein the electronic legal document provider is configured to electronically generate the legal document based on company information of the company.

21. The electronic system of claim 1, wherein the blockchain is configured to implement, and/or to support, a fabric of confidentiality that comprises confidentiality obligations among companies in the network of companies.

22. The electronic system of claim 1, wherein the signed legal document is secured in a blockchain ledger of the blockchain.

23. The electronic system of claim 1, further comprising a user-interface generator configured to provide a user-interface.

24. The electronic system of claim 23, wherein the user-interface is configured to allow a user to enter company information of the company, and to provide the electronic signature for the legal document.

25. The electronic system of claim 23, wherein the user-interface is also configured to allow a user to provide the subscription information for the company.

26. The electronic system of claim 23, wherein the user-interface is configured to allow a user to view a list of companies in the network of companies.

27. The electronic system of claim 23, wherein the user-interface is configured to allow a user to un-subscribe the company for the network of companies.

28. The electronic system of claim 23, wherein the user-interface is configured to allow a user to enter document information regarding another signed legal document for authentication of the other signed legal document.

29. A method performed by an electronic system configured for creating and maintaining a network of companies having legal obligations with each other, the method comprising:
electronically providing a legal document;
obtaining a signed legal document for a company, wherein the signed legal document is based on an electronic signature applied for the legal document;
obtaining, by a subscription engine of the electronic system, subscription information for the company;
registering, by the subscription engine of the electronic system, the company as a subscriber for the network of companies based on the subscription information; and
obtaining, by a processing unit of the electronic system, blockchain information associated with a block of a blockchain, wherein the block of the blockchain is created based on the signed legal document after the company is registered as the subscriber for the network of companies.

30-56. (canceled)

57. A product having one or more non-transitory media storing a set of instructions, wherein an execution of the instructions will cause a method to be performed by an electronic system configured for creating and maintaining a network of companies having legal obligations with each other, the method comprising:
electronically providing a legal document;
obtaining a signed legal document for a company, wherein the signed legal document is based on an electronic signature applied for the legal document;
obtaining, by a subscription engine of the electronic system, subscription information for the company;
registering, by the subscription engine of the electronic system, the company as a subscriber for the network of companies based on the subscription information; and
obtaining, by a processing unit of the electronic system, blockchain information associated with a block of a blockchain, wherein the block of the blockchain is created based on the signed legal document after the company is registered as the subscriber for the network of companies.

58-84. (canceled)
